(19) United States
(12) Patent Application Publication
(10) Pub. No.: US 2009/0098414 A1
(43) Pub. Date: Apr. 16, 2009

(54) METHOD OF MANUFACTURING MAGNETIC RECORDING MEDIUM AND MAGNETIC RECORDING MEDIUM MANUFACTURED BY THE SAME

(75) Inventors: Tadahiro OOISHI, Kanagawa (JP); Kazufumi Omura, Kanagawa (JP); Hitoshi Noguchi, Kanagawa (JP); Hiroaki Takano, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/240,406

(22) Filed: Sep. 29, 2008

(30) Foreign Application Priority Data
Sep. 28, 2007 (JP) 2007-256815
Mar. 26, 2008 (JP) 2008-080264

(51) Int. Cl. G11B 5/706; B05D 5/00

(52) U.S. Cl. 428/836.2; 427/130

(57) ABSTRACT

The present invention relates to a method of manufacturing a magnetic recording medium wherein the magnetic layer coating liquid comprising a ferromagnetic powder having an average particle size of 10 to 40 nm and a moisture content of 0.3 to 3.0 weight percent; a binder (a) comprising 0.2 to 0.7 meq/g of at least one polar group selected from the group consisting of —SO₃M, —OSO₃M, —PO(OM)₂, —OPO(OM)₂, and COOM (M denotes a hydrogen atom or the like) and having a weight average molecular weight of 20,000 to 200,000, and/or (b) comprising 0.5 to 5 meq/g of at least one polar group selected from the group consisting of —CONR¹R², —NR¹R², and —NR⁺R¹R²R³ (wherein R¹, R², and R³ each independently denote a hydrogen atom or the like) and having a weight average molecular weight of 20,000 to 200,000; and a compound comprising at least one carboxyl group and/or hydroxyl group per molecule.

### CROSS-REFERENCE TO RELATED APPLICATIONS

This application claims the benefit of priority under 35 USC 119 to Japanese Patent Application No. 2007-256815 filed on Sep. 28, 2007 and Japanese Patent Application No. 2008-080264 filed on Mar. 26, 2008, which are expressly incorporated herein by reference in their entirety.

### BACKGROUND OF THE INVENTION

1. Field of the Invention

The present invention relates to a method of manufacturing a magnetic recording medium and a magnetic recording medium, and more particularly, to a method of manufacturing a magnetic recording medium that can exhibit good electromagnetic characteristics and inhibit head grime.

2. Discussion of the Background

In recent years, means for rapidly transmitting information have undergone marked development, making it possible to transmit data and images comprising huge amounts of information. As data transmission technology has improved, the need for higher density recording in the recording media and recording and reproduction devices used to record, reproduce, and store information has developed.

In addition to using microgranular magnetic materials, it is known that dispersing microgranular magnetic materials to a high degree and increasing the smoothness of the magnetic layer surface are effective means of achieving good electromagnetic characteristics in the high-density recording region. For example, Japanese Unexamined Patent Publication (KOKAI) No. 2003-132531 or English language family member US 2003/0143323 A1 proposes increasing the quantity of polar groups in the binder to within a prescribed range and controlling the moisture content of the magnetic powder to within a prescribed range to increase adsorption of binder to the magnetic material, prevent aggregation of magnetic material, and enhance dispersion. The contents of these applications re expressly incorporated herein by reference in their entirety.

However, investigation conducted by the present inventors has revealed that in a magnetic recording medium employing a binder in which the quantity of polar groups has been increased and in which the surface properties of the magnetic layer have been enhanced by the method described in Japanese Unexamined Patent Publication (KOKAI) No. 2003-132531, although good electromagnetic characteristics are achieved by enhancing dispersion of the magnetic material and thus enhancing the surface properties of the magnetic layer obtained, accumulation of grime on the head during running is quite pronounced. Head grime increases noise and reduces the service lifetime of the head, and is thus desirably minimized.

### SUMMARY OF THE INVENTION

An aspect of the present invention provides for a magnetic recording medium and a method of manufacturing a magnetic recording medium that can exhibit good electromagnetic characteristics and inhibit head grime.

The present inventors conducted extensive research into achieving the above manufacturing method and magnetic recording medium, resulting in assuming that head grime is caused by the presence on the surface of the magnetic layer of low-molecular-weight components derived from binder in which the quantity of polar groups has been increased. The smoother the surface of the magnetic layer, the greater the contact area becomes between the magnetic layer and the head during running, and the greater the amount is thought to be of adhesion to the head by the above low-molecular-weight components present on the surface of the magnetic layer.

Accordingly, based on the above assumptions, the present inventors conducted research into achieving means of reducing the low-molecular-weight components present on the surface of the magnetic layer, first by employing a binder of relatively high molecular weight in the magnetic layer. However, the results of this research by the present inventors revealed that when a large quantity of polar groups was introduced to enhance dispersibility, regardless of the high-molecular-weight binder employed, the low-molecular-weight components were still present on the surface of the magnetic layer. The present inventors attributed this to the binder, with its heightened adsorption to magnetic material resulting from the incorporation of a large quantity of polar groups, coming into contact with active sites on the surface of the magnetic material, the severing of polymer chains by hydrolysis, and as a result, the release of low-molecular-weight components.

The present inventors conducted further research based on the above assumptions, discovering that, in addition to employing a high-molecular-weight binder into which a large quantity of polar groups had been incorporated, by adjusting the moisture content of the ferromagnetic powder to within a prescribed range and employing a compound comprising at least one carboxyl group and/or hydroxyl group per molecule to form the magnetic layer, it was possible to increase the dispersibility of the magnetic layer while inhibiting severing of the high-molecular-weight binder, and as a result, to obtain a magnetic recording medium having good electromagnetic characteristics in which head grime was inhibited. The present invention was devised on that basis.

An aspect of the present invention relates to a method of manufacturing a magnetic recording medium comprising:

coating a magnetic layer coating liquid on a nonmagnetic support and drying the magnetic layer coating liquid to form a magnetic layer, wherein the magnetic layer coating liquid comprises components A, B and C.

Component A: A ferromagnetic powder having an average particle size ranging from 10 to 40 nm and having a moisture content ranging from 0.3 to 3.0 weight percent;
Component B: a binder (a) comprising 0.2 to 0.7 meq/g of at least one polar group selected from the group consisting of —SO₃M, —OSO₃M, —PO(OM)₂, —OPO(OM)₂, and COOM, wherein M denotes a hydrogen atom, alkali metal, or ammonium, and having a weight average molecular weight ranging from 20,000 to 200,000, and/or (b) comprising 0.5 to 5 meq/g of at least one polar group selected from the group consisting of —CONR¹R², —NR¹R², and —N⁺R¹R²R³, wherein R¹, R², and R³ each independently denote a hydrogen atom or an alkyl group, and having a weight average molecular weight ranging from 20,000 to 200,000; and
Component C: a compound comprising at least one carboxyl group and/or hydroxyl group per molecule.

The above method may comprise preparing the magnetic layer coating liquid by simultaneously mixing components A, B, and C, or by mixing components A and C to obtain a mixture and mixing component B to the mixture.

Component B may be the binder (a) comprising 0.2 to 0.7 meq/g of at least one polar group selected from the group consisting of —SO₃M, —OSO₃M, —PO(OM)₂, —OPO(OM)₂, and COOM, wherein M denotes a hydrogen atom, alkali metal, or ammonium, and having a weight average molecular weight ranging from 20,000 to 200,000.

The compound comprising at least one carboxyl group and/or hydroxyl group per molecule may be a cyclic compound.

The cyclic compound may be at least one compound selected from the group consisting of alicyclic compounds, aromatic compounds, and heterocyclic compounds.

The cyclic structure comprised in the cyclic compound may be at least one selected from the group consisting of cyclohexane rings, benzene rings, pyridine rings, and naphthalene rings.

The above ferromagnetic powder may be a hexagonal ferrite powder.

The binder may be a polyurethane resin.

By the above method, a magnetic recording medium comprising a magnetic layer, the surface of which has a centerline average roughness ranging from 1.0 to 3.0 nm may be manufactured.

A further aspect of the present invention relates to a magnetic recording medium comprising a magnetic layer comprising a ferromagnetic powder and a binder on a nonmagnetic support, manufactured by the above method.

The centerline average roughness of the magnetic layer surface may range from 1.0 to 3.0 nm.

The present invention can provide a magnetic recording medium for high-density recording that can exhibit good electromagnetic characteristics and inhibit head grime.

Other exemplary embodiments and advantages of the present invention may be ascertained by reviewing the present disclosure.

### DETAILED DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Method of Manufacturing Magnetic Recording Medium

The present invention relates to a method of manufacturing a magnetic recording medium comprising coating a magnetic layer coating liquid on a nonmagnetic support and drying the magnetic layer coating liquid to form a magnetic layer. In the above method, the magnetic layer coating liquid comprises components A, B and C below.

Component A: A ferromagnetic powder having an average particle size ranging from 10 to 40 nm and having a moisture content ranging from 0.3 to 3.0 weight percent;

Component B: a binder (a) comprising 0.2 to 0.7 meq/g of at least one polar group selected from the group consisting of —SO₃M, —OSO₃M, —PO(OM)₂, —OPO(OM)₂, and COOM, wherein M denotes a hydrogen atom, alkali metal, or ammonium, and having a weight average molecular weight ranging from 20,000 to 200,000, and/or (b) comprising 0.5 to 5 meq/g of at least one polar group selected from the group consisting of —CONR¹R², —NR¹R², and —N⁺R¹R²R³, wherein R¹, R², and R³ each independently denote a hydrogen atom or an alkyl group) and having a weight average molecular weight ranging from 20,000 to 200,000; and

Component C: a compound comprising at least one carboxyl group and/or hydroxyl group per molecule.

In the method of manufacturing a magnetic recording medium of the present invention, the use of a ferromagnetic powder in the form of a microgranular magnetic material (component A) having an average particle size ranging from 10 to 40 nm with components B and C can increase the smoothness of the surface of the magnetic layer, thereby yielding a magnetic recording medium having good electromagnetic characteristics. More specifically, to increase adsorption of the binder to the magnetic material and enhance dispersibility, a prescribed quantity of the above polar groups is incorporated into the binder of the magnetic layer and the moisture content of the ferromagnetic powder is kept to a prescribed quantity. Thus, the dispersibility of the ferromagnetic powder can be enhanced and the smoothness of the surface of the magnetic layer can be increased. Further, by incorporating a binder of relatively high molecular weight in the form of a binder with a weight average molecular weight of 20,000 to 200,000 into the magnetic layer with the above-described compounds, it is possible to inhibit the accumulation of grime on the head during running by means of the magnetic layer having the above-stated smoothness. This is thought to occur for the following two reasons:

(1) Even when free binder that has not adhered to the magnetic material is present in the outer portion of the magnetic layer, the relatively high molecular weight of the binder can cause it to tend not to adhere to the head, so it may not cause head grime.
(2) The low-molecular-weight components derived from binder are thought to be produced by hydrolysis of the binder due to the binder coming into contact with active sites on the surface of the magnetic material. Since a binder into which a relatively large number of polar groups has been incorporated as set forth above has a high degree of adsorption to magnetic material, the ratio of contact between binder and active sites on the surface of the magnetic layer is high. By contrast, since the above described compound (component C) has high adsorptivity to magnetic material, when employed as a component in the magnetic layer, it is thought to adhere to the surface of the magnetic material and deactivate active sites on the surface of the magnetic material. The generation of low-molecular-weight components by severing of the polymer chains by hydrolysis of the binder is thought to be thus inhibited.

The method of manufacturing a magnetic recording medium of the present invention will be described in detail below.

### Component C

The magnetic layer coating liquid comprises at least one compound (component C) comprising at least one carboxyl group and/or hydroxyl group per molecule. Achieving good dispersion of ferromagnetic powder requires preventing aggregation between ferromagnetic powders. Preventing aggregation between ferromagnetic powders requires causing the binder to adsorb to the surface of the ferromagnetic powder. In this process, causing a compound comprising at least one carboxyl group and/or hydroxyl group per molecule to adsorb to the ferromagnetic powder can prevent aggregation between ferromagnetic powders and enhance the dispersion of the ferromagnetic powders. Further, the compound comprising the carboxyl group and/or hydroxyl group can have high adsorptivity to the ferromagnetic powder and function as a surface modifying agent on the ferromagnetic powder. Thus, it is possible to inhibit the generation of a large quantity of low-molecular-weight components derived from component B due to contact between ferromagnetic powder (component A) and binder (component B).

The above compound can comprise just a carboxyl group or a hydroxyl group, or may comprise both. The number of these groups per molecule of the compound is at least 1, preferably 1 to 5, and more preferably, 1 to 3.

So long as the above compound (so-called “surface-modifying agent”) comprises at least 1 carboxyl group and/or hydroxyl group per molecule, it may be a cyclic compound or chain compound, but a cyclic compound is desirable.

The cyclic structure contained in the above cyclic compound may be that of an aliphatic ring, aromatic ring, or hetero ring. That is, examples of the above cyclic compound are one or more members selected from the group consisting of alicyclic compounds, aromatic compounds, and heterocyclic compounds. The cyclic structure may be in the form of a single ring or a condensed ring. There may be one or more cyclic structures contained in the molecule, and the structure may be one in which different types of cyclic structures are linked by linking groups. For example, the cyclic structure contained in the above cyclic compound may suitably be one or more selected from the group consisting of cyclohexane rings, benzene rings, pyridine rings, and naphthalene rings.

When the cyclic compound is an alicyclic compound, the cyclic structure contained is, for example, an optionally condensed aliphatic ring having 5 to 30 carbon atoms, desirably an optionally condensed aliphatic ring having 5 to 10 carbon atoms, and preferably, a cyclohexane ring.

When the cyclic compound is an aromatic compound, the aromatic ring contained is desirably a five-membered ring, six-membered ring, seven-membered ring, or a ring formed by the condensation of a combination thereof, preferably a five-membered ring or six-membered ring, and more preferably, a six-membered ring. Specific examples are benzene rings, naphthalene rings, anthracene rings, and phenanthrene rings. Of these, benzene rings and naphthalene rings are desirable.

When the cyclic compound is a heterocyclic compound, the hetero atoms contained in the hetero ring are, for example, nitrogen atoms, oxygen atoms, or sulfur atoms, with nitrogen atoms being desirable. The hetero ring has, for example, 1 to 30 carbon atoms, desirably 1 to 20 carbon atoms, and preferably, 1 to 12 carbon atoms. Specific examples of the hetero ring are pyrrole rings, pyrazole rings, imidazole rings, pyridine rings, furan rings, thiophene rings, oxazole rings, thiazole rings, benzo-condensed products thereof, and hetero-condensed products thereof, with pyridine rings being preferred.

The cyclic compound can comprise substituents other than carboxyl groups and hydroxyl groups. Examples of such substituents are halogen atoms (fluorine, chlorine, bromine, and iodine atoms), cyano groups, nitro groups, alkyl groups having 1 to 16 carbon atoms, alkenyl groups having 1 to 16 carbon atoms, alkynyl groups having 2 to 16 carbon atoms, halogen-substituted alkyl groups having 1 to 16 carbon atoms, alkoxy groups having 1 to 16 carbon atoms, acyl groups having 2 to 16 carbon atoms, alkylthio groups having 1 to 16 carbon atoms, acyloxy groups having 2 to 16 carbon atoms, alkoxycarbonyl groups having 2 to 16 carbon atoms, carbamoyl groups, alkyl-substituted carbamoyl group having 2 to 16 carbon atoms, and acylamino groups having 2 to 16 carbon atoms. The substituent is desirably a halogen atom, cyano group, alkyl group having 1 to 6 carbon atoms, halogen-substituted alkyl group having 1 to 6 carbon atoms; preferably a halogen atom, alkyl group having 1 to 4 carbon atoms, or halogen-substituted alkyl group having 1 to 4 carbon atoms; and more preferably, a halogen atom, alkyl group having 1 to 3 carbon atoms, or trifluoromethyl group.

Desirable specific examples of the cyclic compound are 1-naphthoic acid, catechol, phenol, phthalic acid, 4-tert-butylphenol, 4-tert-butylbenzoic acid, 4-butylphenol, 4-hydroxypyridine, and cyclohexanecarboxylic acid. Preferred examples are catechol and 1-naphthoic acid, with 1-naphthoic acid being of even greater preference.

Component C can be readily synthesized by known methods and may be commercially available.

The content of component C in the magnetic layer can be suitably set, but is desirably 0.1 to 10 weight parts, preferably 0.5 to 10 weight parts, and more preferably, 1 to 8 weight parts per 100 weight parts of ferromagnetic powder. By keeping the content of component C less than or equal to the upper limit of the above range, plasticizing and peeling of the film can be inhibited. Additionally, by keeping the content of component C greater than or equal to the lower limit of the above range, head grime can be prevented.

### Binder (Component B)

The binder (component B) contained in the magnetic layer coating liquid is a binder (a) comprising 0.2 to 0.7 meq/g of at least one polar group selected from the group consisting of —SO₃M, —OSO₃M, —PO(OM)₂, —OPO(OM)₂, and COOM (wherein M denotes a hydrogen atom, alkali metal, or ammonium) and having a weight average molecular weight ranging from 20,000 to 200,000, and/or (b) comprising 0.5 to 5 meq/g of at least one polar group selected from the group consisting of —CONR¹R², —NR¹R², and —N⁺R¹R²R³ (wherein R¹, R², and R³ each independently denote a hydrogen atom or an alkyl group) and having a weight average molecular weight ranging from 20,000 to 200,000. That is, the binder may meet the requirements of either (a) or (b), or both. The binder desirably satisfies the requirements of at least (a), and is preferably (a). Any one from among —SO₃M, —OSO₃M, —PO(OM)₂, and COOM is desirable as the polar group in (a). The above alkyl group desirably has 1 to 18 carbon atoms, and may have a linear or branched structure. The content of the polar group in the binder (a) is 0.2 to 0.7 meq/g, desirably 0.25 to 0.6 meq/g, and preferably, 0.3 to 0.5 meq/g. The content of the polar group in (b) is 0.5 to 5 meq/g, desirably 1 to 4 meq/g, and preferably, 1.5 to 3.5 meq/g. When the content of the polar group falls outside the above range, it becomes difficult to increase the dispersibility of the magnetic material and achieve a magnetic layer of good surface smoothness. One or more types of the above polar groups may be incorporated. The content of the polar groups in (a) and (b) refers to the combined content when multiple types of polar group are present. The polar group can be incorporated in desired quantity into the binder by addition polymerization or copolymerization, for example.

The weight average molecular weight of the binder falls within a range of 20,000 to 200,000. When the weight average molecular weight is less than 20,000, head grime becomes pronounced. This is thought to be due to an increase in the quantity of low-molecular-weight component in the outer portion of the magnetic layer. When the weight average molecular weight exceeds 200,000, dispersibility diminishes and it becomes difficult to obtain good electromagnetic characteristics. The weight average molecular weight is desirably 30,000 to 180,000, preferably 50,000 to 150,000.

So long as the binder satisfies the conditions of (a) and/or (b) above and has a weight average molecular weight within the above-stated range, the structure and the like of the binder are not specifically limited. Conventionally known thermoplastic resins, thermosetting resins, reactive resins, polymers, mixtures thereof, and the like can be employed. Examples are: polymers and copolymers comprising structural units in the form of vinyl chloride, vinyl acetate, vinyl alcohol, maleic acid, acrylic acid, acrylic ester, vinylidene chloride, acrylonitrile, methacrylic acid, methacrylic ester, styrene, butadiene, ethylene, vinyl butyral, vinyl acetal, or vinyl ether; polyurethane resins; and various rubber-based resins. Examples of thermosetting resins and reactive resins are: phenol resin, epoxy resin, polyurethane cured resins, urea resins, melamine resins, alkyd resins, acrylic reactive resins, formaldehyde resins, silicone resins, epoxy-polyamide resins, mixtures of a polyester resin and an isocyanate prepolymer, mixtures of a polyester polyol and a polyisocyanate, and mixtures of polyurethane and a polyisocyanate. These resins are described in detail in Handbook of plastics published by Asakura Shoten, which is expressly incorporated herein by reference in its entirety. It is also possible to employ known electron beam-cured resins in each layer. Examples and manufacturing methods of such resins are described in Japanese Unexamined Patent Publication (KOKAI) Showa No. 62-256219, which is expressly incorporated herein by reference in its entirety. The above-listed resins may be used singly or in combination. Those comprising polyurethane are desirable. Examples of suitable resins are combinations of a polyurethane resin with one or more selected from among vinyl chloride resin, vinyl chloride-vinyl acetate copolymers, vinyl chloride-vinyl acetate-vinyl alcohol copolymers, and vinyl chloride-vinyl acetate-maleic anhydride copolymers; and combinations of polyisocyanate with the same. In the manufacturing method of the present invention, particularly in a magnetic recording medium in which polyurethane resin is employed, it is possible to effectively inhibit head grime.

Known polyurethane resins may be employed, such as polyester polyurethane, polyether polyurethane, polyether polyester polyurethane, polycarbonate polyurethane, polyester polycarbonate polyurethane, and polycaprolactone polyurethane.

The above binder can be synthesized by known methods. Further, commercial products can be employed as they are, or desirable quantities of polar groups can be incorporated for use.

As set forth below, the magnetic recording medium that is manufactured by the manufacturing method of the present invention may comprise a nonmagnetic layer comprising a nonmagnetic powder and a binder between the magnetic layer and the nonmagnetic support. Examples of binders that are suitable for use in the nonmagnetic layer are the binders that are suitable for use in the magnetic layer. Binders that are employed in common magnetic layers may also be employed.

The above binder is employed, for example, in a range of 5 to 50 weight percent, desirably in a range of 10 to 30 weight percent, relative to the nonmagnetic powder employed in the nonmagnetic layer or ferromagnetic powder employed in the magnetic layer. Vinyl chloride resin is desirably combined for use in a range of 5 to 30 weight percent when employed. Polyurethane resin is desirably combined for use in a range of 2 to 20 weight percent when employed. And polyisocyanate is desirably combined for use in a range of 2 to 20 weight percent when employed. However, when a small amount of dechlorination causes head corrosion, it is also possible to employ polyurethane alone, or employ polyurethane and isocyanate alone. When polyurethane is employed, a glass transition temperature of −50 to 150° C., preferably 0 to 100° C., an elongation at break of 100 to 2,000 percent, a stress at break of 0.05 to 10 kg/mm² (approximately 0.49 to 98 MPa), and a yield point of 0.05 to 10 kg/mm² (approximately 0.49 to 98 MPa) are desirable.

Examples of polyisocyanates are tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co., Ltd.; and Desmodule L, Desmodule IL, Desmodule N and Desmodule HL manufactured by Sumitomo Bayer Co., Ltd. They can be used in each layer singly or in combinations of two or more by exploiting differences in curing reactivity.

As set forth above, the use of component C is thought to reduce head grime because when a high-molecular-weight binder is employed, component C can deactivate active sites on the surface of the ferromagnetic powder, preventing the binder from undergoing hydrolysis and the like to produce low-molecular-weight components, thereby reducing the quantity of low-molecular-weight components causing head grime on the magnetic layer surface. The weight average molecular weight of the binder (resin component) can be measured by the following method.

(Method of Measuring the Weight Average Molecular Weight of a Resin Component)

The binder is evaluated by gel permeation chromatography (GPC). The weight average molecular weight of the resin component is the value obtained by conversion based on standard polystyrene samples using dimethyl formamide (DMF) solvent.

### Surface Roughness of the Magnetic Layer

The surface roughness of the magnetic layer of the magnetic recording medium manufactured by the method of manufacturing a magnetic recording medium of the present invention desirably ranges from 1.0 to 3.0 nm as a centerline average roughness. When the centerline average roughness of the magnetic layer is equal to or lower than 3.0 nm, better electromagnetic characteristics can be achieved, and when equal to or greater than 1.0 nm, running stability can increase. The centerline average roughness of the magnetic layer is desirably 1.5 to 3.0 nm, preferably 1.5 to 2.5 nm. Use of a magnetic layer coating liquid comprising components A, B, and C permits the formation of a magnetic layer of good surface smoothness. The surface smoothness of the magnetic layer can also be controlled through the particle size of the ferromagnetic powder, the dispersion conditions of the magnetic layer coating liquid, calendering conditions, adjustment of the quantity of filler in the nonmagnetic support, the use of an undercoating layer for smoothness, and the like.

### Ferromagnetic Powder (Component A)

Hexagonal ferrite powder and ferromagnetic metal powder can be employed as the ferromagnetic powder (component A) contained in the magnetic layer coating liquid. Hexagonal ferrite powder is desirably employed. When the length of the signal recording region approaches the size of the magnetic material contained in the magnetic layer, it becomes impossible to create a distinct magnetization transition state, essentially precluding recording. Thus, the shorter the recording wavelength becomes, the smaller the magnetic material should be. To achieve good electromagnetic characteristics in the present invention, ferromagnetic powder with an average particle size of 10 to 40 nm is employed. When the average particle size is less than 10 nm, it becomes difficult to disperse individual particles. This means that it becomes difficult to cover individual magnetic particles with binder. In this case, the surface of several aggregated magnetic particles is covered with binder, and thus there will be aggregates in which no binder is present between the magnetic particles, weakening the bonds between magnetic particles. This is thought to decrease the coating strength of the magnetic layer. When the average particle size exceeds 40 nm, it becomes difficult to achieve good electromagnetic characteristics. The average particle size is desirably 15 to 40 nm, preferably 15 to 30 nm.

The average particle size of the ferromagnetic powder can be measured by the following method.

Ferromagnetic powder is photographed at a magnification of 100,000-fold with a model H-9000 transmission electron microscope made by Hitachi, and the photographs are printed on photographic paper at a total magnification of 500,000 to obtain particle photographs. Target magnetic particles are selected in the particle photographs, the outlines of the particles are traced with a digitizer, and the particle size is measured with KS-400 image analysis software from Carl Zeiss. The size of 500 particles is measured. The average value of the size of the particles measured by the above-described method is then adopted as the average particle size of the ferromagnetic powder.

The size of a powder such as the magnetic material (referred to as the “powder size” hereinafter) in the present invention is denoted: (1) by the length of the major axis constituting the powder, that is, the major axis length, when the powder is acicular, spindle-shaped, or columnar in shape (and the height is greater than the maximum major diameter of the bottom surface); (2) by the maximum major diameter of the tabular surface or bottom surface when the powder is tabular or columnar in shape (and the thickness or height is smaller than the maximum major diameter of the tabular surface or bottom surface); and (3) by the diameter of an equivalent circle when the powder is spherical, polyhedral, or of unspecified shape and the major axis constituting the powder cannot be specified based on shape. The “diameter of an equivalent circle” refers to that obtained by the circular projection method.

The average powder size of the powder is the arithmetic average of the above powder size and is calculated by measuring five hundred primary particles in the above-described method. The term “primary particle” refers to a nonaggregated, independent particle.

The average acicular ratio of the powder refers to the arithmetic average of the value of the (major axis length/minor axis length) of each powder, obtained by measuring the length of the minor axis of the powder in the above measurement, that is, the minor axis length. The term “minor axis length” means the length of the minor axis constituting a powder for a powder size of definition (1) above, and refers to the thickness or height for definition (2) above. For (3) above, the (major axis length/minor axis length) can be deemed for the sake of convenience to be 1, since there is no difference between the major and minor axes.

When the shape of the powder is specified, for example, as in particle size definition (1) above, the average particle size refers to the average major axis length. For definition (2) above, the average particle size refers to the average plate diameter, with the arithmetic average of (maximum major diameter/thickness or height) being referred to as the average plate ratio. For definition (3), the average particle size refers to the average diameter (also called the average particle diameter). In the measurement of powder size, the standard deviation/average value, expressed as a percentage, is defined as the coefficient of variation.

The moisture content of the ferromagnetic powder contained in the magnetic layer coating liquid employed in the method of manufacturing a magnetic recording medium of the present invention is 0.3 to 3 weight percent, desirably 0.5 to 1.5 weight percent, and preferably, 0.8 to 1.5 weight percent. Keeping the moisture content to within the above range cab optimize adsorption of the binder (component B) containing a prescribed quantity of polar groups to the magnetic material and enhance dispersibility, making it possible to achieve a magnetic recording medium exhibiting a high S/N ratio. A moisture content in the ferromagnetic powder of less than 0.3 weight percent is undesirable in that the binder does not adsorb adequately to reduce dispersibility. A moisture content exceeding 3 weight percent is undesirable in that an excessive reaction takes place between the binder and the curing agent, such as polyisocyanate, in the magnetic layer coating liquid, raising the viscosity of the magnetic layer coating liquid. The moisture content can be adjusted by drying or adding water after manufacturing the magnetic material. The moisture content can be measured by the Karl Fischer's method. The Karl Fischer's method of measuring moisture content can be employed as set forth below.

The temperature of a vaporizer is set to 120° C. A carrier gas (N₂) is passed through at a flow rate of 300 mL/min. About 300 mg of sample is precisely weighed out and a trace water meter (CA-05) with vaporizer (VA-05) made by Mitsubishi Chemicals (Ltd.) is employed to obtain the absolute moisture content. The moisture content of the sample is then calculated from the following equation:

Moisture content(%)=A/(10×S)
where A denotes moisture content (micrograms) and S denotes sample quantity (mg).

Examples of the ferromagnetic powder contained in the magnetic layer coating liquid are ferromagnetic metal powders and hexagonal ferrite powders.

### (i) Hexagonal Ferrite Powder

Examples of hexagonal ferrite powders are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed.

As the hexagonal ferrite powder, those having an average plate diameter ranging from 10 to 40 nm are employed. The average plate diameter preferably ranges from 15 to 40 nm, more preferably 15 to 30 nm.

An average plate ratio [arithmetic average of (plate diameter/plate thickness)] preferably ranges from 1 to 15, more preferably 1 to 7. When the average plate diameter ranges from 1 to 15, adequate orientation can be achieved while maintaining high filling property, as well as increased noise due to stacking between particles can be suppressed. The specific surface area by BET method (S_{BET}) within the above particle size range is preferably equal to or higher than 40 m²/g, more preferably 40 to 200 m²/g, and particularly preferably, 60 to 100 m²/g.

Narrow distributions of particle plate diameter and plate thickness of the hexagonal ferrite powder are normally good. About 500 particles can be randomly measured in a transmission electron microscope (TEM) photograph of particles to measure the particle plate diameter and plate thickness, as set forth above. The distributions of particle plate diameter and plate thickness are often not a normal distribution. However, when expressed as the standard deviation to the average size, σ/average size may be 0.1 to 1.0. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known.

A coercivity (Hc) of the hexagonal ferrite powder of about 143.3 to 318.5 kA/m (approximately 1800 to 4,000 Oe) can normally be achieved. The coercivity (Hc) of the hexagonal ferrite powder preferably ranges from 167.2 to 294.5 kA/m (approximately 2,100 to 3,700 Oe), more preferably 199.0 to 278.6 kA/m (approximately 2,500 to 3,500 Oe). The coercivity (Hc) can be controlled by particle size (plate diameter and plate thickness), the types and quantities of elements contained, substitution sites of the element, the particle producing reaction conditions, and the like.

The φₘ of the magnetic layer can be controlled by the saturation magnetization (σₛ) of the hexagonal ferrite powder. The higher saturation magnetization (σₛ) is generally preferred, however, it tends to decrease with decreasing particle size. The saturation magnetization (σₛ) of the hexagonal ferrite powder can be selected based on the desired φₘ, and preferably 30 to 80 A·m²/kg (30 to 80 emu/g). Known methods of improving saturation magnetization (σₛ) are combining spinel ferrite with magnetoplumbite ferrite, selection of the type and quantity of elements incorporated, and the like. It is also possible to employ W-type hexagonal ferrite. When dispersing the hexagonal ferrite powder, the surface of the hexagonal ferrite powder can be processed with a substance suited to a dispersion medium and a polymer. The pH of the hexagonal ferrite powder is also important to dispersion. A pH of about 4 to 12 is usually optimum for the dispersion medium and polymer. From the perspective of the chemical stability and storage properties of the medium, a pH of about 6 to 11 can be selected. Since moisture contained in the hexagonal ferrite powder also affects dispersion, the ferromagnetic powder having the above-described moisture content is employed in the present invention.

Methods of manufacturing the hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to equal to or greater than 100° C.; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. Any manufacturing method can be selected in the present invention. As needed, the hexagonal ferrite powder can be surface treated with Al, Si, P, or an oxide thereof. The quantity can be set to 0.1 to 10 weight percent of the hexagonal ferrite powder. When applying a surface treatment, the quantity of a lubricant such as a fatty acid that is adsorbed is desirably not greater than 100 mg/m². The hexagonal ferrite powder will sometimes contain inorganic ions such as soluble Na, Ca, Fe, Ni, or Sr. These are desirably substantially not present, but seldom affect characteristics at equal to or less than 200 ppm.

### (ii) Ferromagnetic Metal Powder

The ferromagnetic metal powder employed in the magnetic layer is not specifically limited, but preferably a ferromagnetic metal power comprised primarily of α-Fe. In addition to prescribed atoms, the following atoms can be contained in the ferromagnetic metal powder: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. Particularly, incorporation of at least one of the following in addition to α-Fe is desirable: Al, Si, Ca, Y, Ba, La, Nd, Co, Ni, and B. Incorporation of at least one selected from the group consisting of Co, Y and Al is particularly preferred. The Co content preferably ranges from 0 to 40 atom percent, more preferably from 15 to 35 atom percent, further preferably from 20 to 35 atom percent with respect to Fe. The content of Y preferably ranges from 1.5 to 12 atom percent, more preferably from 3 to 10 atom percent, further preferably from 4 to 9 atom percent with respect to Fe. The A1 content preferably ranges from 1.5 to 12 atom percent, more preferably from 3 to 10 atom percent, further preferably from 4 to 9 atom percent with respect to Fe.

These ferromagnetic metal powders may be pretreated prior to dispersion with dispersing agents, lubricants, surfactants, antistatic agents, and the like, described further below. Specific examples are described in Japanese Examined Patent Publication (KOKOKU) Showa Nos. 44-14090, 45-18372, 47-22062, 47-22513, 46-28466, 46-38755, 47-4286, 47-12422, 47-17284, 47-18509, 47-18573, 39-10307, and 46-39639; and U.S. Pat. Nos. 3,026,215, 3,031,341, 3,100,194, 3,242,005, and 3,389,014, which are expressly incorporated herein by reference in their entirety.

The ferromagnetic metal powder may contain a small quantity of hydroxide or oxide. Ferromagnetic metal powders obtained by known manufacturing methods may be employed. The following are examples of methods of manufacturing ferromagnetic metal powders: methods of reduction with compound organic acid salts (chiefly oxalates) and reducing gases such as hydrogen; methods of reducing iron oxide with a reducing gas such as hydrogen to obtain Fe or Fe—Co particles or the like; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining powder by vaporizing a metal in a low-pressure inert gas. Any one from among the known method of slow oxidation, that is, immersing the ferromagnetic metal powder thus obtained in an organic solvent and drying it; the method of immersing the ferromagnetic metal powder in an organic solvent, feeding in an oxygen-containing gas to form a surface oxide film, and then conducting drying; and the method of adjusting the partial pressures of oxygen gas and an inert gas without employing an organic solvent to form a surface oxide film, may be employed.

The specific surface area by BET method of the ferromagnetic metal powder employed in the magnetic layer is preferably 45 to 100 m²/g, more preferably 50 to 80 m²/g. At 45 m²/g and above, low noise is achieved. At 100 m²/g and below, good surface properties are achieved. The crystallite size of the ferromagnetic metal powder is preferably 40 to 180 Angstroms, more preferably 40 to 150 Angstroms, and still more preferably, 40 to 110 Angstroms. The major axis length of the ferromagnetic metal powder ranges from 10 to 40 nm, preferably from 15 to 30 nm. The acicular ratio of the ferromagnetic metal powder is preferably equal to or greater than 3 and equal to or less than 15, more preferably equal to or greater than 3 and equal to or less than 12. The σₛ of the ferromagnetic metal powder is preferably 80 to 180 A·m²/kg, more preferably 80 to 150 A·m²/kg, and still more preferably, 80 to 120 A·m²/kg. The coercivity of the ferromagnetic powder is preferably 2,000 to 3,500 Oe, approximately 160 to 280 kA/m, more preferably 2,200 to 3,000 Oe, approximately 176 to 240 kA/m.

As set forth above, the moisture content of the ferromagnetic metal powder ranges from 0.3 to 3 weight percent. The moisture content of the ferromagnetic metal powder is desirably optimized based on the type of binder. The pH of the ferromagnetic metal powder is desirably optimized depending on what is combined with the binder. A range of 4 to 12 can be established, with 6 to 10 being preferred. As needed, the ferromagnetic metal powder can be surface treated with Al, Si, P, or an oxide thereof. The quantity can be set to 0.1 to 10 weight percent of the ferromagnetic metal powder. When applying a surface treatment, the quantity of a lubricant such as a fatty acid that is adsorbed is desirably not greater than 100 mg/m². The ferromagnetic metal powder will sometimes contain inorganic ions such as soluble Na, Ca, Fe, Ni, or Sr. These are desirably substantially not present, but seldom affect characteristics at equal to or less than 200 ppm. The ferromagnetic metal powder employed in the present invention desirably has few voids; the level is preferably equal to or less than 20 volume percent, more preferably equal to or less than 5 volume percent. As stated above, so long as the particle size characteristics are satisfied, the ferromagnetic metal powder may be acicular, rice grain-shaped, or spindle-shaped. The SFD of the ferromagnetic metal powder itself is desirably low, with equal to or less than 0.8 being preferred. The Hc distribution of the ferromagnetic metal powder is desirably kept low. When the SFD is equal to or lower than 0.8, good electromagnetic characteristics are achieved, output is high, and magnetic inversion is sharp, with little peak shifting, in a manner suited to high-density digital magnetic recording. To keep the Hc low, the methods of improving the particle size distribution of goethite in the ferromagnetic metal powder and preventing sintering may be employed.

In the manufacturing method of the present invention, known techniques regarding binders, lubricants, dispersion agents, additives, solvents, dispersion methods and the like for magnetic layer, nonmagnetic layer and backcoat layer that is optionally provided can be suitably applied. In particular, known techniques regarding the quantity and types of binders, and quantity added and types of additives and dispersion agents can be applied.

Additives may be added to the magnetic layer coating liquid as needed. Examples of additives are: abrasives, lubricants, antifungal agents, antistatic agents, oxidation inhibitors, solvents, and carbon black. Examples of such additives are: molybdenum disulfide, tungsten disulfide, graphite, boron nitride, graphite fluoride, silicone oil, polar group-comprising silicone, fatty acid-modified silicone, fluorosilicone, fluoroalcohols, fluoroesters, polyolefin, polyglycol, polyphenyl ether, phenyl phosphonic acid, benzyl phosphonic acid, phenethyl phosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluoylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, nonylphenylphosphonic acid, other aromatic ring-comprising organic phosphonic acids, alkali metal salts thereof, octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, isoeicosylphosphonic acid, other alkyl phosphonoic acid, alkali metal salts thereof, phenyl phosphoric acid, benzyl phosphoric acid, phenethyl phosphoric acid, α-methylbenzylphosphoric acid, 1-methyl-1-phenethylphosphoric acid, diphenylmethylphosphoric acid, diphenyl phosphoric acid, benzylphenyl phosphoric acid, α-cumyl phosphoric acid, toluoyl phosphoric acid, xylyl phosphoric acid, ethylphenyl phosphoric acid, cumenyl phosphoric acid, propylphenyl phosphoric acid, butylphenyl phosphoric acid, heptylphenyl phosphoric acid, octylphenyl phosphoric acid, nonylphenyl phosphoric acid, other aromatic phosphoric esters, alkali metal salts thereof, octyl phosphoric acid, 2-ethylhexylphosphoric acid, isooctyl phosphoric acid, isononyl phosphoric acid, isodecyl phosphoric acid, isoundecyl phosphoric acid, isododecyl phosphoric acid, isohexadecyl phosphoric acid, isooctyldecyl phosphoric acid, isoeicosyl phosphoric acid, other alkyl ester phosphoric acids, alkali metal salts thereof, alkylsulfonic acid ester, alkali metal salts thereof, fluorine-containing alkyl sulfuric acid esters, alkali metal salts thereof, lauric acid, myristic acid, palmitic acid, stearic acid, behenic acid, oleic acid, linolic acid, linoleic acid, elaidic acid, erucic acid, other monobasic fatty acids comprising 10 to 24 carbon atoms (which may contain an unsaturated bond or be branched), metal salts thereof, butyl stearate, octyl stearate, amyl stearate, isooctyl stearate, octyl myristate, butyl laurate, butoxyethyl stearate, anhydrosorbitan monostearate, anhydrosorbitan tristearate, other monofatty esters, difatty esters, or polyfatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 22 carbon atoms (which may contain an unsaturated bond or be branched), alkoxyalcohol having 12 to 22 carbon atoms (which may contain an unsaturated bond or be branched) or a monoalkyl ether of an alkylene oxide polymer, fatty acid amides with 2 to 22 carbon atoms, and aliphatic amines with 8 to 22 carbon atoms. Compounds having aralkyl groups, aryl groups, or alkyl groups substituted with groups other than hydrocarbon groups, such as nitro groups, F, Cl, Br, CF₃, CCl₃, CBr₃, and other halogen-containing hydrocarbons in addition to the above hydrocarbon groups, may also be employed.

It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K.K.), which is expressly incorporated herein by reference in its entirety.

These lubricants, antistatic agents and the like need not be 100 percent pure and may contain impurities, such as isomers, unreacted material, by-products, decomposition products, and oxides in addition to the main components. These impurities are preferably comprised equal to or less than 30 weight percent, and more preferably equal to or less than 10 weight percent.

Specific examples of these additives are: NAA-102, hydrogenated castor oil fatty acid, NAA-42, Cation SA, Nymeen L-201, Nonion E-208, Anon BF and Anon LG manufactured by NOF Corporation; FAL-205 and FAL-123 manufactured by Takemoto Oil & Fat Co., Ltd.; NJLUB OL manufactured by New Japan Chemical Co. Ltd.; TA-3 manufactured by Shin-Etsu Chemical Co. Ltd.; Amide P and Duomine TDO manufactured by Lion Corporation; BA-41G manufactured by Nisshin OilliO, Ltd.; and Profan 2012E, Newpole PE61 and Ionet MS-400 manufactured by Sanyo Chemical Industries, Ltd.

### Dispersing Agent

Component C can serve as a dispersing agent, and can be added to a nonmagnetic layer coating liquid. In the present invention, component C can be employed together with other compounds having a dispersion-improving effect. The dispersion agent suitable use together with component C is preferably at least one selected from the group consisting of alicyclic compounds, aromatic compounds, and heterocyclic compounds. Among component C and cyclic compounds other than component C, those suitable for use as a dispersion agent are: phenol, benzoic acid, cyclohexanol, cyclohexane carboxylic acid, 1-naphthoic acid, catechol, and structural isomers thereof, phthalic acid and structural isomers thereof, cyclohexane dicarboxylic acid and structural isomers thereof, 4-tert-butylphenol and structural isomers thereof, 4-butylphenol and structural isomers thereof, 4-hydroxypyridine and structural isomers thereof, 4-tert-butylbenzoic acid and structural isomers thereof, and niacin.

Carbon black may be added to the magnetic layer as needed. Examples of types of carbon black that are suitable for use in the magnetic layer are: furnace black for rubber, thermal for rubber, black for coloring, and acetylene black. It is preferable that the specific surface area is 5 to 500 m²/g, the DBP oil absorption capacity is 10 to 400 ml/100 g, the particle diameter is 5 to 300 nm, the pH is 2 to 10, the moisture content is 0.1 to 10 percent, and the tap density is 0.1 to 1 g/ml.

Specific examples of types of carbon black employed are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemical Corporation; CONDUCTEX SC, RAVEN 150, 50, 40, 15 and RAVEN MT-P from Columbia Carbon Co., Ltd.; and Ketjen Black EC from Ketjen Black International Co., Ltd. The carbon black employed may be surface-treated with a dispersant or grafted with resin, or have a partially graphite-treated surface. The carbon black may be dispersed in advance into the binder prior to addition to the magnetic coating liquid. These carbon blacks may be used singly or in combination. When employing carbon black, the quantity preferably ranges from 0.1 to 30 weight percent with respect to the weight of the magnetic material. In the magnetic layer, carbon black can work to prevent static, reduce the coefficient of friction, impart light-blocking properties, enhance film strength, and the like; the properties vary with the type of carbon black employed. Accordingly, the type, quantity, and combination of carbon blacks employed in the present invention may be determined separately for the magnetic layer and the nonmagnetic layer based on the objective and the various characteristics stated above, such as particle size, oil absorption capacity, electrical conductivity, and pH, and be optimized for each layer. For example, the Carbon Black Handbook compiled by the Carbon Black Association, which is expressly incorporated herein by reference in its entirety, may be consulted for types of carbon black suitable for use in the magnetic layer.

### Abrasives

Known materials chiefly having a Mohs' hardness of equal to or greater than 6 may be employed either singly or in combination as abrasives. These include: α-alumina, β-alumina, silicon carbide, chromium oxide, cerium oxide, α-iron oxide, corundum, synthetic diamond, silicon nitride, titanium carbide, titanium oxide, silicon dioxide, and boron nitride. Complexes of these abrasives (obtained by surface treating one abrasive with another) may also be employed. There are cases in which compounds or elements other than the primary compound are contained in these abrasives; the effect does not change so long as the content of the primary compound is equal to or greater than 90 percent. The particle size of the abrasive is preferably 0.01 to 2 micrometers. To enhance electromagnetic characteristics, a narrow particle size distribution is desirable. Abrasives of differing particle size may be incorporated as needed to improve durability; the same effect can be achieved with a single abrasive as with a wide particle size distribution. It is preferable that the tap density is 0.3 to 2 g/cc, the moisture content is 0.1 to 5 percent, the pH is 2 to 11, and the specific surface area is 1 to 30 m²/g. The shape of the abrasive employed may be acicular, spherical, cubic, plate-shaped or the like. However, a shape comprising an angular portion is desirable due to high abrasiveness. Specific examples are AKP-12, AKP-15, AKP-20, AKP-30, AKP-50, HIT-20, HIT-30, HIT-55, HIT-60, HIT-70, HIT-80, and HIT-100 made by Sumitomo Chemical Co., Ltd.; ERC-DBM, HP-DBM, and HPS-DBM made by Reynolds Corp.; WA10000 made by Fujimi Abrasive Corp.; UB20 made by Uemura Kogyo Corp.; G-5, Chromex U2, and Chromex U1 made by Nippon Chemical Industrial Co., Ltd.; TF100 and TF140 made by Toda Kogyo Corp.; Beta Random Ultrafine made by Ibiden Co., Ltd.; and B-3 made by Showa Kogyo Co., Ltd. These abrasives may be added as needed to the nonmagnetic layer. Addition of abrasives to the nonmagnetic layer can be done to control surface shape, control how the abrasive protrudes, and the like. The particle size and quantity of the abrasives added to the magnetic layer and nonmagnetic layer should be set to optimal values.

Known organic solvents can be used in any ratio. Examples are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane.

These organic solvents need not be 100 weight percent pure and may contain impurities such as isomers, unreacted materials, by-products, decomposition products, oxides and moisture in addition to the main components. The content of these impurities is preferably equal to or less than 30 weight percent, more preferably equal to or less than 10 weight percent. Preferably the same type of organic solvent is employed in the magnetic layer and in the nonmagnetic layer. However, the amount added may be varied. The stability of coating is increased by using a solvent with a high surface tension (such as cyclohexanone or dioxane) in the nonmagnetic layer. Specifically, it is important that the arithmetic mean value of the magnetic layer solvent composition be not less than the arithmetic mean value of the nonmagnetic layer solvent composition. To improve dispersion properties, a solvent having a somewhat strong polarity is desirable. It is desirable that solvents having a dielectric constant equal to or higher than 15 are comprised equal to or higher than 50 percent of the solvent composition. Further, the dissolution parameter is desirably 8 to 11.

The types and quantities of dispersing agents, lubricants, and surfactants employed in the magnetic layer may differ from those employed in the nonmagnetic layer, described further below, in the present invention. For example (the present invention not being limited to the embodiments given herein), a dispersing agent usually has the property of adsorbing or bonding by means of a polar group. In the magnetic layer, the dispersing agent adsorbs or bonds by means of the polar group primarily to the surface of the ferromagnetic powder, and in the nonmagnetic layer, primarily to the surface of the nonmagnetic powder. It is surmised that once a cyclic compound has adsorbed or bonded, it tends not to dislodge readily from the surface of a metal, metal compound, or the like. Accordingly, the surface of a ferromagnetic powder or the surface of a nonmagnetic powder becomes covered with the alicyclic ring, aromatic ring, heterocyclic ring, and the like. This enhances the compatibility of the ferromagnetic powder or nonmagnetic powder with the binder resin component, further improving the dispersion stability of the ferromagnetic powder or nonmagnetic powder. Further, lubricants are normally present in a free state. Thus, it is conceivable to use fatty acids with different melting points in the nonmagnetic layer and magnetic layer to control seepage onto the surface, employ esters with different boiling points and polarity to control seepage onto the surface, regulate the quantity of the surfactant to enhance coating stability, and employ a large quantity of lubricant in the nonmagnetic layer to enhance the lubricating effect. All or some part of the additives employed in the present invention can be added in any of the steps during the manufacturing of coating liquids for the magnetic layer and nonmagnetic layer. For example, there are cases where they are mixed with the ferromagnetic powder prior to the kneading step; cases where they are added during the step in which the ferromagnetic powder, binder, and solvent are kneaded; cases where they are added during the dispersion step; cases where they are added after dispersion; and cases where they are added directly before coating.

### Nonmagnetic Layer

Details of the nonmagnetic layer will be described below. In the manufacturing method of the present invention, it is possible to form a magnetic layer by coating a magnetic layer coating liquid directly on a nonmagnetic support and drying the coating liquid. It is also possible to manufacture a magnetic recording medium comprising a nonmagnetic layer and a magnetic layer in this order on a nonmagnetic support by coating a nonmagnetic layer coating liquid on a nonmagnetic support, and then coating a magnetic layer coating liquid thereover and drying it. The nonmagnetic layer coating liquid can comprise a nonmagnetic powder and a binder, and optionally comprise additives. Both organic and inorganic substances may be employed as the nonmagnetic powder in the nonmagnetic layer coating liquid. Carbon black may also be employed. Examples of inorganic substances are metals, metal oxides, metal carbonates, metal sulfates, metal nitrides, metal carbides, and metal sulfides.

Specifically, titanium oxides such as titanium dioxide, cerium oxide, tin oxide, tungsten oxide, ZnO, ZrO₂, SiO₂, Cr₂O₃, α-alumina with an α-conversion rate of 90 to 100 percent, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide may be employed singly or in combinations of two or more. α-iron oxide and titanium oxide are preferred.

The nonmagnetic powder may be acicular, spherical, polyhedral, or plate-shaped. The crystallite size of the nonmagnetic powder preferably ranges from 4 nm to 500 nm, more preferably from 40 to 100 nm. A crystallite size falling within a range of 4 nm to 500 nm is desirable in that it facilitates dispersion and imparts a suitable surface roughness. The average particle diameter of the nonmagnetic powder preferably ranges from 5 nm to 500 nm. As needed, nonmagnetic powders of differing average particle diameter may be combined; the same effect may be achieved by broadening the average particle distribution of a single nonmagnetic powder. The preferred average particle diameter of the nonmagnetic powder ranges from 10 to 200 nm. Within a range of 5 nm to 500 nm, dispersion is good and good surface roughness can be achieved.

The specific surface area of the nonmagnetic powder preferably ranges from 1 to 150 m²/g, more preferably from 20 to 120 m²/g, and further preferably from 50 to 100 m²/g. Within the specific surface area ranging from 1 to 150 m²/g, suitable surface roughness can be achieved and dispersion is possible with the desired quantity of binder. Oil absorption capacity using dibutyl phthalate (DBP) preferably ranges from 5 to 100 mL/100 g, more preferably from 10 to 80 mL/100 g, and further preferably from 20 to 60 mL/100 g. The specific gravity ranges from, for example, 1 to 12, preferably from 3 to 6. The tap density ranges from, for example, 0.05 to 2 g/mL, preferably from 0.2 to 1.5 g/mL. A tap density falling within a range of 0.05 to 2 g/mL can reduce the amount of scattering particles, thereby facilitating handling, and tends to prevent solidification to the device. The pH of the nonmagnetic powder preferably ranges from 2 to 11, more preferably from 6 to 9. When the pH falls within a range of 2 to 11, the coefficient of friction does not become high at high temperature or high humidity or due to the freeing of fatty acids. The moisture content of the nonmagnetic powder ranges from, for example, 0.1 to 5 weight percent, preferably from 0.2 to 3 weight percent, and more preferably from 0.3 to 1.5 weight percent. A moisture content falling within a range of 0.1 to 5 weight percent is desirable because it can produce good dispersion and yield a stable coating viscosity following dispersion. An ignition loss of equal to or less than 20 weight percent is desirable and nonmagnetic powders with low ignition losses are desirable.

When the nonmagnetic powder is an inorganic powder, the Mohs' hardness is preferably 4 to 10. Durability can be ensured if the Mohs' hardness ranges from 4 to 10. The stearic acid (SA) adsorption capacity of the nonmagnetic powder preferably ranges from 1 to 20 μmol/m², more preferably from 2 to 15 μmol/m². The heat of wetting in 25° C. water of the nonmagnetic powder is preferably within a range of 200 to 600 erg/cm² (approximately 200 to 600 mJ/m²). A solvent with a heat of wetting within this range may also be employed. The quantity of water molecules on the surface at 100 to 400° C. suitably ranges from 1 to 10 pieces per 100 Angstroms. The pH of the isoelectric point in water preferably ranges from 3 to 9. The surface of these nonmagnetic powders is preferably treated with Al₂O₃, SiO₂, TiO₂, ZrO₂, SnO2, Sb₂O₃, and ZnO. The surface-treating agents of preference with regard to dispersibility are Al₂O₃, SiO₂, TiO₂, and ZrO₂, and Al₂O₃, SiO₂ and ZrO₂ are further preferable. They may be employed singly or in combination. Depending on the objective, a surface-treatment coating layer with a coprecipitated material may also be employed, the coating structure which comprises a first alumina coating and a second silica coating thereover or the reverse structure thereof may also be adopted. Depending on the objective, the surface-treatment coating layer may be a porous layer, with homogeneity and density being generally desirable.

Specific examples of nonmagnetic powders suitable for use in the nonmagnetic layer coating liquid are: Nanotite from Showa Denko K. K.; HIT-100 and ZA-G1 from Sumitomo Chemical Co., Ltd.; DPN-250, DPN-250BX, DPN-245, DPN-270BX, DPN-550BX and DPN-550RX from Toda Kogyo Corp.; titanium oxide TTO-51B, TTO-55A, TTO-55B, TTO-55C, TTO-55S, TTO-55D, SN-100, MJ-7, α-iron oxide E270, E271 and E300 from Ishihara Sangyo Co., Ltd.; STT-4D, STT-30D, STT-30 and STT-65C from Titan Kogyo K. K.; MT-100S, MT-100T, MT-150W, MT-500B, MT-600B, MT-100F and MT-500HD from Tayca Corporation; FINEX-25, BF-1, BF-10, BF-20 and ST-M from Sakai Chemical Industry Co., Ltd.; DEFIC-Y and DEFIC-R from Dowa Mining Co., Ltd.; AS2BM and TiO2P25 from Nippon Aerogil; 100A and 500A from Ube Industries, Ltd.; Y-LOP from Titan Kogyo K. K.; and sintered products of the same. Particular preferable nonmagnetic powders are titanium dioxide and α-iron oxide.

Carbon black may be combined with nonmagnetic powder in the nomagnetic layer coating liquid to reduce surface resistivity, reduce light transmittance, and achieve a desired micro-Vickers hardness in the nonmagnetic layer. The micro-Vickers hardness of the nonmagnetic layer is normally 25 to 60 kg/mm² (approximately 245 to 588 MPa), desirably 30 to 50 kg/mm² (approximately 294 to 490 MPa) to adjust head contact. It can be measured with a thin film hardness meter (HMA-400 made by NEC Corporation) using a diamond triangular needle with a tip radius of 0.1 micrometer and an edge angle of 80 degrees as indenter tip. “Techniques for evaluating thin-film mechanical characteristics,” Realize Corp., for details. The content of the above publication is expressly incorporated herein by reference in its entirety. The light transmittance is generally standardized to an infrared absorbance at a wavelength of about 900 nm equal to or less than 3 percent. For example, in VHS magnetic tapes, it has been standardized to equal to or less than 0.8 percent. To this end, furnace black for rubber, thermal black for rubber, black for coloring, acetylene black and the like may be employed.

The specific surface area of the carbon black employed in the nonmagnetic layer coating liquid is, for example, 100 to 500 m²/g, preferably 150 to 400 m²/g. The DBP oil absorption capability is, for example, 20 to 400 mL/100 g, preferably 30 to 200 mL/100 g. The particle diameter of the carbon black is, for example, 5 to 80 nm, preferably 10 to 50 nm, and more preferably, 10 to 40 nm. It is preferable that the pH of the carbon black is 2 to 10, the moisture content is 0.1 to 10 percent, and the tap density is 0.1 to 1 g/mL.

Specific examples of types of carbon black employed in the nonmagnetic layer coating liquid are: BLACK PEARLS 2000, 1300, 1000, 900, 905, 800, 880, 700 and VULCAN XC-72 from Cabot Corporation; #3050B, #3150B, #3250B, #3750B, #3950B, #950, #650B, #970B, #850B and MA-600 from Mitsubishi Chemical Corporation; CONDUCTEX SC, RAVEN 8800, 8000, 7000, 5750, 5250, 3500, 2100, 2000, 1800, 1500, 1255 and 1250 from Columbia Carbon Co., Ltd.; and Ketjen Black EC from Ketjen Black International Co., Ltd.

The carbon black employed may be surface-treated with a dispersant or grafted with resin, or have a partially graphite-treated surface. The carbon black may be dispersed in advance into the binder prior to addition to the nonmagnetic coating liquid. These carbon blacks may be used singly or in combination. When employing carbon black, the quantity of the carbon black is preferably within a range not exceeding 50 weight percent of the inorganic powder as well as not exceeding 40 weight percent of the total weight of the nonmagnetic layer. For example, the Carbon Black Handbook compiled by the Carbon Black Association, which is expressly incorporated herein by reference in its entirety, may be consulted for types of carbon black suitable for use in the nonmagnetic layer.

Based on the objective, an organic powder may be added to the nonmagnetic layer coating liquid. Examples of such an organic powder are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed. The manufacturing methods described in Japanese Unexamined Patent Publication (KOKAI) Showa Nos. 62-18564 and 60-255827 may be employed. The contents of the above applications are expressly incorporated herein by reference in their entirety.

Binders, lubricants, dispersing agents, additives, solvents, dispersion methods, and the like suited to the magnetic layer may be adopted to the nonmagnetic layer coating liquid. In particular, known techniques for the quantity and type of binder and the quantity and type of additives and dispersion agents employed in the magnetic layer may be adopted thereto.

### Nonmagnetic Support

Known films of the following may be employed as the nonmagnetic support in the present invention: polyethylene terephthalate, polyethylene naphthalate and other polyesters, polyolefins, cellulose triacetate, polycarbonate, polyamides, polyimides, polyamidoimides, polysulfones, aromatic polyamides, polybenzooxazoles and the like. Supports having a glass transition temperature of equal to or higher than 100° C. are preferably employed. The use of polyethylene naphthalate, aramid, or some other high-strength support is particularly desirable. As needed, layered supports such as disclosed in Japanese Unexamined Patent Publication (KOKAI) Heisei No. 3-224127, which is expressly incorporated herein by reference in its entirety, may be employed to vary the surface roughness of the magnetic surface and support surface. These supports may be subjected beforehand to corona discharge treatment, plasma treatment, adhesion enhancing treatment, heat treatment, dust removal, and the like.

The center surface average surface roughness (SRa) of the support measured with an optical interferotype surface roughness meter HD-2000 made by WYKO is preferably equal to or less than 8.0 nm, more preferably equal to or less than 4.0 nm, further preferably equal to or less than 2.0 nm. Not only does such a support desirably have a low center surface average surface roughness, but there are also desirably no large protrusions equal to or higher than 0.5 μm. The surface roughness shape may be freely controlled through the size and quantity of filler added to the support as needed. Examples of such fillers are oxides and carbonates of elements such as Ca, Si, and Ti, and organic fine powders such as acrylic-based one. The support desirably has a maximum height Rₘₐₓ equal to or less than 1 μm, a ten-point average roughness R_{Z} equal to or less than 0.5 μm, a center surface peak height R_{P} equal to or less than 0.5 μm, a center surface valley depth R_{V} equal to or less than 0.5 μm, a center-surface surface area percentage Sr of 10 percent to 90 percent, and an average wavelength λₐ of 5 to 300 μm. To achieve desired electromagnetic characteristics and durability, the surface protrusion distribution of the support can be freely controlled with fillers. It is possible to control within a range from 0 to 2,000 protrusions of 0.01 to 1 μm in size per 0.1 mm².

The F-5 value of the nonmagnetic support employed in the present invention preferably ranges from 5 to 50 kg/mm² (approximately 49 to 490 MPa). The thermal shrinkage rate of the support after 30 min at 100° C. is preferably equal to or less than 3 percent, more preferably equal to or less than 1.5 percent. The thermal shrinkage rate after 30 min at 80° C. is preferably equal to or less than 1 percent, more preferably equal to or less than 0.5 percent. The breaking strength of the nonmagnetic support preferably ranges from 5 to 100 kg/mm² (approximately 49 to 980 MPa). The modulus of elasticity preferably ranges from 100 to 2,000 kg/mm² (approximately 0.98 to 19.6 GPa). The thermal expansion coefficient preferably ranges from l- to 10⁻⁸/° C., more preferably from 10⁻⁵ to 10⁻⁶/° C. The moisture expansion coefficient is preferably equal to or less than 10⁻⁴/RH percent, more preferably equal to or less than 10⁻⁵/RH percent. These thermal characteristics, dimensional characteristics, and mechanical strength characteristics are desirably nearly equal, with a difference equal to less than 10 percent, in all in-plane directions in the support.

An undercoating layer can be provided in the method of manufacturing a magnetic recording medium of the present invention. Providing an undercoating layer can enhance adhesive strength between the support and the magnetic layer or nonmagnetic layer. For example, a polyester resin that is soluble in solvent can be employed as the undercoating layer to enhance adhesion. As described below, a smoothing layer can be provided as an undercoating layer.

### Layer Structure

In the magnetic recording medium manufactured by the manufacturing method of the present invention, the thickness of the nonmagnetic support preferably ranges from 3 to 80 micrometers, more preferably from 3 to 50 micrometers, further preferably from 3 to 10 micrometers. When an undercoating layer is provided between the nonmagnetic support and the nonmagnetic layer or the magnetic layer, the thickness of the undercoating layer ranges from, for example, 0.01 to 0.8 micrometer, preferably 0.02 to 0.6 micrometer.

An intermediate layer can be provided between the support and the nonmagnetic layer or the magnetic layer and/or between the support and the backcoat layer to improve smoothness. For example, the intermediate layer can be formed by coating and drying a coating liquid comprising a polymer on the surface of the nonmagnetic support, or by coating a coating liquid comprising a compound (radiation-curable compound) comprising intramolecular radiation-curable functional groups and then irradiating it with radiation to cure the coating liquid.

A radiation-curable compound having a number average molecular weight ranging from 200 to 2,000 is desirably employed. When the molecular weight is within the above range, the relatively low molecular weight can facilitate coating flow during the calendering step, increasing moldability and permitting the formation of a smooth coating.

A radiation-curable compound in the form of a bifunctional acrylate compound with the molecular weight of 200 to 2,000 is desirable. Bisphenol A, bisphenol F, hydrogenated bisphenol A, hydrogenated bisphenol F, and compounds obtained by adding acrylic acid or methacrylic acid to alkylene oxide adducts of these compounds are preferred.

The radiation-curable compound can be used in combination with a polymeric binder. Examples of the binder employed in combination are conventionally known thermoplastic resins, thermosetting resins, reactive resins, and mixtures thereof. When the radiation employed in the curing process is UV radiation, a polymerization initiator is desirably employed in combination. A known photoradical polymerization initiator, photocationic polymerization initiator, photoamine generator, or the like can be employed as the polymerization initiator.

A radiation-curable compound can also be employed in the nonmagnetic layer.

The thickness of the magnetic layer can be optimized based on the saturation magnetization of the head employed, the length of the head gap, and the recording signal band, and is normally 10 to 150 nm, preferably 20 to 120 nm, more preferably 30 to 100 nm, further preferably 30 to 80 nm. The thickness variation (σ/δ) in the magnetic layer is preferably within ±50 percent, more preferably within ±30 percent. At least one magnetic layer is sufficient. The magnetic layer may be divided into two or more layers having different magnetic characteristics, and a known configuration relating to multilayered magnetic layer may be applied.

The thickness of the nonmagnetic layer ranges from, for example, 0.1 to 3.0 μm, preferably 0.2 to 2.0 μm, and more preferably 0.3 to 1.5 μm. The nonmagnetic layer in the present invention is effective so long as it is substantially nonmagnetic. For example, it exhibits the effect of the present invention even when it comprises impurities or trace amounts of magnetic material that have been intentionally incorporated, and can be viewed as substantially having the same configuration as the magnetic recording medium of the present invention. The term “substantially nonmagnetic” is used to mean having a residual magnetic flux density in the nonmagnetic layer of equal to or less than 10 mT, or a coercive force Hc of equal to or less than 7.96 kA/m (100 Oe), it being preferable not to have a residual magnetic flux density or coercive force at all.

### Backcoat Layer

A backcoat layer can be provided on the surface of the nonmagnetic support, opposite to the surface on which the magnetic layer is provided. The backcoat layer desirably comprises carbon black and inorganic powder. The formula of the magnetic layer or nonmagnetic layer can be applied to the binder and various additives of the backcoat layer. The formula of the nonmagnetic layer is preferred. The backcoat layer is preferably equal to or less than 0.9 micrometer, more preferably 0.1 to 0.7 micrometer, in thickness.

Details of the magnetic recording medium manufactured by the manufacturing method of the present invention, such as preferred physical properties, are as set forth below for the magnetic recording medium of the present invention.

The method of manufacturing a magnetic recording medium of the present invention will be described below through specific embodiments of the detailed procedure.

The magnetic layer coating liquid employed in the manufacturing method of the present invention comprises components A, B, and C. The details of these components are as set forth above. The surface on which the magnetic layer coating liquid is coated does not have to be the surface of the nonmagnetic support; when manufacturing a magnetic recording medium having a nonmagnetic layer, the magnetic layer coating liquid can be directly or indirectly coated on the nonmagnetic layer.

The process for manufacturing coating liquids for forming magnetic, nonmagnetic and backcoat layers comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these applications are incorporated herein by reference in their entirety. Further, glass beads may be employed to disperse the coating liquids for magnetic, nonmagnetic and backcoat layers, with a dispersing medium with a high specific gravity such as zirconia beads, titania beads, and steel beads being suitable for use. The particle diameter and fill ratio of these dispersing media can be optimized for use. A known dispersing device may be employed.

For the addition of the above-described compound (component C) to be effective, component C is desirably present at the stage where the ferromagnetic powder and binder are brought into contact. This is to prevent the binder from contacting the surface of the ferromagnetic powder before component C has adhered to the surface of the ferromagnetic powder. Accordingly, the magnetic layer coating liquid is desirably prepared by simultaneously mixing component A (ferromagnetic powder), component B (binder), and component C (cyclic compound), or by mixing components A and C to obtain a mixture and then mixing component B to the mixture. Preparation by mixing component B to a mixture obtained by mixing components A and C is preferred. Mixing components A and C first can allow a larger amount of component C to adsorb to the surface of the ferromagnetic powder, inhibiting the generation of low-molecular-weight components derived from the binder.

Components A, B, and C are desirably specifically mixed by the following methods:

(1) Components A and C are dry dispersed for about 15 to 30 minutes in advance, and then added to an organic solvent. Component B can be simultaneously added with the dispersion, or can be added after the dispersion.
(2) Components A and C are dispersed for about 15 to 30 minutes in an organic solvent, and then dried. The dry mixture is suitably comminuted and then added to an organic solvent. Component B can be simultaneously added with the mixture, or added after the mixture.
(3) Components A and C are dispersed for about 15 to 30 minutes in an organic solvent, after which component B is added.
(4) Components A, B, and C are simultaneously added to an organic solvent and dispersed.

In the process of manufacturing the magnetic recording medium, for example, the nonmagnetic layer coating liquid is coated in a quantity calculated to yield a coating of prescribed thickness on the surface of a running nonmagnetic support to form the nonmagnetic layer, after which the magnetic layer coating liquid is coated thereover in a quantity calculated to yield a coating of prescribed thickness to form the magnetic layer. Multiple magnetic layer coating liquids can be successively or simultaneously coated in a multilayer coating, and the nonmagnetic layer coating liquid and magnetic layer coating liquid can be successively or simultaneously coated in a multilayer coating. The coating apparatus used to coat the magnetic layer coating liquid or nonmagnetic layer coating liquid can be an air doctor coater, blade coater, rod coater, extrusion coater, air knife coater, squeeze coater, impregnating coater, reverse roll coater, transfer roll coater, gravure coater, kiss coater, cast coater, spray coater, spin coater, or the like. Details of the coating apparatus are described in, for example, “The Most Recent Coating Techniques,” published by the Sogo Technology Center (Ltd.) (May 31, 1983), which is expressly incorporated herein by reference in its entirety.

As for a magnetic tape, the coating layer that is formed by applying the magnetic layer coating liquid can be magnetic field orientation processed using cobalt magnets or solenoids on the ferromagnetic powder contained in the coating layer. As for a disk, an adequately isotropic orientation can be achieved in some products without orientation using an orientation device, but the use of a known random orientation device in which cobalt magnets are alternately arranged diagonally, or alternating fields are applied by solenoids, is desirable. In the case of ferromagnetic metal powder, the term “isotropic orientation” generally refers to a two-dimensional in-plane random orientation, which is desirable, but can refer to a three-dimensional random orientation achieved by imparting a perpendicular component. Further, a known method, such as opposing magnets of opposite poles, can be employed to effect perpendicular orientation, thereby imparting an isotropic magnetic characteristic in the peripheral direction. Perpendicular orientation is particularly desirable when conducting high-density recording. Spin coating can be used to effect peripheral orientation.

The drying position of the coating is desirably controlled by controlling the temperature and flow rate of drying air, and coating speed. A coating speed of 20 m/min to 1,000 m/min and a dry air temperature of equal to or higher than 60° C. are desirable. Suitable predrying can be conducted prior to entry into the magnet zone.

The coated stock material thus obtained can be temporarily wound on a take-up roll, and then unwound from the take-up roll and calendered.

For example, super calender rolls can be employed in calendering. Calendering can enhance surface smoothness, eliminate voids produced by the removal of solvent during drying, and increase the fill rate of the ferromagnetic powder in the magnetic layer, thus yielding a magnetic recording medium of good electromagnetic characteristics. The calendering step is desirably conducted by varying the calendering conditions in response to the smoothness of the surface of the coated stock material.

The surface smoothness of the coated stock material can be controlled by controlling the calender roll temperature, calender roll speed, and calender roll tension. Taking into account the properties of a particulate medium, it is desirable to control the surface smoothness by means of the calender roll pressure and calender roll temperature. Generally, the calender roll pressure is reduced, or the calender roll temperature is lowered, to diminish the surface smoothness of the final product. Conversely, the calender roll pressure can be increased or the calender roll temperature can be raised to increase the surface smoothness of the final product.

Alternatively, the magnetic recording medium following the calendering step can be thermally processed to induce thermosetting. Such thermal processing can be suitably determined based on the blending formula of the magnetic layer coating liquid. The thermal processing temperature is, for example, 35 to 100° C., desirably 50 to 80° C. The thermal processing time is, for example, 12 to 72 hours, desirably 24 to 48 hours.

Rolls of a heat-resistant plastic such as epoxy, polyimide, polyamide, or polyamidoimide, can be employed as the calender rolls. Processing with metal rolls is also possible.

As for the calendaring conditions, the calender roll temperature ranges from, for example, 60 to 100° C., preferably 70 to 100° C., and more preferably 80 to 100° C. The pressure ranges from, for example, 100 to 500 kg/cm (98 to 490 kN/m), preferably 200 to 450 kg/cm (196 to 441 kN/m), and more preferably 300 to 400 kg/cm (294 to 392 kN/m). To improve surface smoothness of the magnetic layer, the nonmagnetic layer surface can be calendered. Calendering for the nonmagnetic layer is preferably conducted under the above-described conditions.

The magnetic recording medium obtained can be cut to desired size with a cutter or the like. The cutter is not specifically limited, but desirably comprises multiple sets of a rotating upper blade (male blade) and lower blade (female blade). The slitting speed, engaging depth, peripheral speed ratio of the upper blade (male blade) and lower blade (female blade) (upper blade peripheral speed/lower blade peripheral speed), period of continuous use of slitting blade, and the like are suitably selected.

### Magnetic Recording Medium

The present invention further relates to a magnetic recording medium comprising a magnetic layer comprising a ferromagnetic powder and a binder on a nonmagnetic support. The magnetic recording medium of the present invention is manufactured by the manufacturing method of the present invention. Details of the magnetic recording medium of the present invention, such as various components comprised and preferred physical properties of various layers, are as set forth above.

The physical properties of the magnetic recording medium of the present invention will be described below.

### Physical Properties

The coercivity (Hc) of the magnetic layer is preferably 143.2 to 318.3 kA/m (approximately 1800 to 4000 Oe), more preferably 159.2 to 278.5 kA/m (approximately 2000 to 3500 Oe). Narrower coercivity distribution is preferable. The SFD and SFDr are preferably equal to or lower than 0.8, more preferably equal to or lower than 0.5.

The coefficient of friction of the magnetic recording medium relative to the head is, for example, equal to or less than 0.5 and preferably equal to or less than 0.3 at temperatures ranging from −10° C. to 40° C. and humidity ranging from 0 percent to 95 percent, the surface resistivity on the magnetic surface preferably ranges from 10⁴ to 10⁸ ohm/sq, and the charge potential preferably ranges from −500 V to +500 V. The modulus of elasticity at 0.5 percent extension of the magnetic layer preferably ranges from 0.98 to 19.6 GPa (approximately 100 to 2,000 kg/mm²) in each in-plane direction. The breaking strength preferably ranges from 98 to 686 MPa (approximately 10 to 70 kg/mm²). The modulus of elasticity of the magnetic recording medium preferably ranges from 0.98 to 14.7 GPa (approximately 100 to 1500 kg/mm²) in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent.

The glass transition temperature (i.e., the temperature at which the loss elastic modulus of dynamic viscoelasticity peaks as measured at 110 Hz with a dynamic viscoelastometer, such as RHEOVIBRON made by A&D Co. Ltd) of the magnetic layer preferably ranges from 50 to 180° C., and that of the nonmagnetic layer preferably ranges from 0 to 180° C. The loss elastic modulus preferably falls within a range of 1×10⁷ to 8×10⁸ Pa (approximately 1×10⁸ to 8×10⁹ dyne/cm²) and the loss tangent is preferably equal to or less than 0.2. Adhesion failure tends to occur when the loss tangent becomes excessively large. These thermal characteristics and mechanical characteristics are desirably nearly identical, varying by equal to or less than 10 percent, in each in-plane direction of the medium.

The residual solvent contained in the magnetic layer is preferably equal to or less than 100 mg/m² and more preferably equal to or less than 10 mg/m². The void ratio in the coated layers, including both the nonmagnetic layer and the magnetic layer, is preferably equal to or less than 40 volume percent, more preferably equal to or less than 30 volume percent. Although a low void ratio is preferable for attaining high output, there are some cases in which it is better to ensure a certain level based on the object. For example, in many cases, larger void ratio permits preferred running durability in disk media in which repeat use is important.

Physical properties of the nonmagnetic layer and magnetic layer may be varied based on the objective in the magnetic recording medium of the present invention. For example, the modulus of elasticity of the magnetic layer may be increased to improve running durability while simultaneously employing a lower modulus of elasticity than that of the magnetic layer in the nonmagnetic layer to improve the head contact of the magnetic recording medium.

### EXAMPLES

The present invention will be described in detail below based on examples. However, the present invention is not limited to the examples. The term “parts” given in Examples are weight parts unless specifically stated otherwise.

### Example 1

Magnetic layer coating liquid

| | |
|---|---|
| Component A) Hexagonal barium ferrite powder | 100 parts |
| Composition other than oxygen (molar ratio): | |
| Ba/Fe/Co/Zn = 1/9/0.2/1 | |
| Hc: 176 kA/m (approximately 2200 Oe) | |
| Average plate diameter: 20 nm | |
| Average plate ratio: 3 | |
| Specific surface area by BET method: 65 m²/g | |
| σs: 49 A·m²/kg (approximately 49 emu/g) | |
| pH: 7 | |
| Component B) Polyurethane resin based on | 17 parts |
| branched side chain-comprising polyester | |
| polyol/diphenylmethane diisocyanate | |
| (—SO₃Na = 0.35 meq/g) | |
| Component C) Cyclic compound (1-naphthoic acid) | 5 parts |
| α-Al₂O₃ (particle size: 0.15 micrometer) | 5 parts |
| Diamond powder (average particle diameter: 60 nm) | 1 part |
| Carbon black (average particle diameter: 20 nm) | 1 part |
| Cyclohexanone | 110 parts |
| Methyl ethyl ketone | 100 parts |
| Toluene | 100 parts |
| Butyl stearate | 2 parts |
| Stearic acid | 1 part |

Nonmagnetic layer coating liquid

| | |
|---|---|
| Nonmagnetic inorganic powder (α-iron oxide) | 85 parts |
| Surface treatment layer: Al₂O₃, SiO₂ | |
| Average major axis length: 0.15 micrometer | |
| Average acicular ratio: 7 | |
| Specific surface area by BET method: 52 m²/g | |
| pH: 8 | |
| Carbon black | 15 parts |
| Vinyl chloride copolymer (MR110 made by | 10 parts |
| Nippon Zeon Co., Ltd) | |
| Polyurethane resin based on branched side | 10 parts |
| chain-comprising polyester polyol/diphenylmethane | |
| diisocyanate (—SO₃Na = 0.2 meq/g) | |
| Phenylphosphonic acid | 3 parts |
| Cyclohexanone | 140 parts |
| Methyl ethyl ketone | 170 parts |
| Butyl stearate | 2 part |
| Stearic acid | 1 part |

Backcoat layer coating liquid

| | |
|---|---|
| Microgranular carbon black powder | 100 parts |
| (BPr800 made by Cabot Corporation, | |
| average particle size: 17 nm) | |
| Coarse granular carbon black powder | 10 parts |
| (Thermal black made by Cancarb Limited., | |
| average particle size: 270 nm) | |
| Nitrocellulose resin | 140 parts |
| Polyurethane resin | 15 parts |
| Polyester resin | 5 parts |
| Dispersing agents: | |
| Copper oleate | 5 parts |
| Copper phthalocyanine | 5 parts |
| Barium sulfate | 5 parts |
| (BF-1 made by Sakai Chemical Industry | |
| Co., Ltd., average particle diameter: | |
| 50 nm, Mohs' hardness: 3) | |
| Methyl ethyl ketone | 1200 parts |
| Butyl acetate | 300 parts |
| Toluene | 600 parts |

The various components of the above nonmagnetic layer coating liquid were first kneaded in an open kneader and then dispersed in a sand mill. Five parts of polyisocyanate (Coronate L, made by Nippon Polyurethane Industry Co., Ltd.) were added to the dispersion obtained, 40 parts of a mixed solvent of methyl ethyl ketone and cyclohexanone were further added, and the mixture was mixed and stirred. The mixture was then filtered with a filter having a pore diameter of 1 micrometer to prepare the nonmagnetic layer coating liquid.

The magnetic layer coating liquid was prepared as follows. The hexagonal ferrite powder and 1-naphthoic acid were dry dispersed for 15 minutes, the dispersion was kneaded with the above-listed magnetic layer components in an open kneader, and the mixture was dispersed in a sand mill. Three parts of polyisocyanate (Coronate L, made by Nippon Polyurethane Industry Co., Ltd.) were added to the dispersion obtained, 40 parts of a mixed solvent of methyl ethyl ketone and cyclohexanone were further added, and the mixture was mixed and stirred. The mixture was then filtered with a filter having a pore diameter of 1 micrometer to obtain the magnetic layer coating liquid.

The backcoat layer coating liquid was prepared as follows. The above-listed components were kneaded in a continuous kneader and dispersed in a sand mill. To the dispersion obtained were added 40 parts of polyisocyanate (Coronate L, made by Nippon Polyurethane Industry Co., Ltd.) and 1,000 parts of methyl ethyl ketone. The mixture was stirred and then filtered with a filter having a pore diameter of 1 micrometer.

The nonmagnetic layer coating liquid was coated in a quantity calculated to yield a nonmagnetic layer with a dry thickness of 1.5 micrometers and the magnetic layer coating liquid was coated in a quantity calculated to yield a magnetic layer with a dry thickness of 0.10 micrometer on a support (biaxially-drawn polyethylene terephthalate) 7 micrometer in thickness in such a manner as to obtain a total dry tape thickness of 8.6 micrometers in a simultaneous multilayer coating, and the coating liquids were dried. Subsequently, the backcoat layer coating liquid was coated to the opposite surface from the magnetic layer surface in a quantity calculated to yield a backcoat layer with a dry thickness of 0.5 micrometer.

Subsequently, the medium was calendered with a seven-stage calender comprised of only metal rolls at a rate of 100 m/min, a linear pressure of 350 kg/cm (343 kN/m), and a temperature of 80° C. The roll obtained was heat treated for 48 hours at 50° C. Next, the medium was slit to ½ inch width to prepare a magnetic tape.

### Examples 2 to 5, 14, 15, 23 to 25 and Comparative Examples 1, 5, 6, 9, and 10

With the exceptions that the polyurethane resin contained in the magnetic layer coating liquid and nonmagnetic layer coating liquid was replaced with the polyurethane resin having the weight average molecular weight, polar group type, and polar group quantity indicated in Table 1, magnetic tapes were manufactured by the same method as in Example 1.

### Examples 6 to 13, 16 to 20, and Comparative Example 2

With the exception that component C, and/or the quantity thereof, contained in the magnetic layer coating liquid was changed as indicated in Table 1, magnetic tapes were manufactured by the same method as in Example 1.

### Examples 21 and 22

With the exception that the hexagonal ferrite contained in the magnetic layer coating liquid was changed to the hexagonal ferrite having the average plate diameter shown in Table 1, magnetic tapes were manufactured by the same method as in Example 1.

### Example 28

A magnetic tape was manufactured by the same method as in Example 1, with the exceptions that the hexagonal ferrite powder contained in the magnetic layer coating liquid was changed to a ferromagnetic metal powder having the average major axis length shown in Table 1, the compound shown in Table 1 was employed as component C, the magnetic layer and the nonmagnetic layer were oriented by cobalt magnets having a magnetic force of 0.3 T (3,000 G) and solenoids having a magnetic force of 0.15 T (1,500 G) while the magnetic layer and nonmagnetic layer were still wet during the course of forming the magnetic layer (simultaneous multilayer coating) and then dried, and a backcoat layer was coated in a quantity calculated to yield a dry thickness of 0.5 micrometer.

### Example 29

With the exceptions that hexagonal ferrite powder, binder, and 1-naphthoic acid were simultaneously dispersed during the preparation of the magnetic layer coating liquid, a magnetic tape was manufactured by the same method as in Example 1.

### Comparative Example 3

With the exception that component C was not added to the magnetic layer coating liquid, a magnetic tape was manufactured by the same method as in Example 1.

### Comparative Example 4

With the exceptions that the polyurethane resin contained in the magnetic layer coating liquid and nonmagnetic layer coating liquid was replaced with the polyurethane resin having the weight average molecular weight, type of polar group, and quantity of polar group shown in Table 1, and component C was not added, a magnetic tape was manufactured by the same method as in Example 1.

### Comparative Examples 7 and 8

With the exception that the hexagonal ferrite contained in the magnetic layer coating liquid was replaced with the hexagonal ferrite having the average plate diameter shown in Table 1, magnetic tapes were manufactured by the same method as in Example 1.

### Examples 26 and 27, Comparative Examples 11 and 12

With the exception that the hexagonal ferrite contained in the magnetic layer coating liquid was replaced with the hexagonal ferrite having the water content shown in Table 1, magnetic tapes were manufactured by the same method as in Example 1.

### 1. The Magnetic Layer Surface Roughness

The magnetic layer surface roughness was measured under the following conditions:

Device: Nanoscope III made by Veeco Japan.
Mode: Contact mode
Measurement scope: a 40 micrometer square
Scan lines: 512*512
Scan speed: 2 Hz
Scan direction: Longitudinal direction of the medium.

### 2. The S/N Ratio

(Running Method)

Employing a magnetic tape tester, a tape sample 800 m in length per roll was run at a running speed of 6 m/s, a back tension of 0.7 N, and a tape/head angle (½ of the lap angle) of 10 degrees while winding/taking up the tape between two reels.

Employing a linear head, a 19.0 MHz (linear recording density of 160 kfci) signal was recorded and reproduced while running the tape sample in the above-described “Running method.” The reproduction signal was inputted to an R3361C made by Advantest Corp., the peak signal of 19.0 MHz was adopted as the signal output (S), and the integral noise (N) was measured over the range of 1 to 37.7 MHz, excluding 19.0 MHz±0.3 MHz. The ratio was adopted as the S/N ratio. A value of equal to or higher than 20 dB was considered to indicate good electromagnetic characteristics.

### 3. Head Grime

A tape sample was run 500 m in the above-described “Running method.” After running the tape, the head was examined by optical microscope and the head grime was evaluated. The image of the head that was examined by optical microscope was input into a PC and binary processed. (The head was observed at a magnification of 50.) A surface ratio of the tape sliding surface of the head that was 0 to 5 percent covered with grime was evaluated as “Excellent,” more than 5 percent but equal to or less than 15 percent as “good,” and more than 15 percent as “X.”

TABLE 1

Component A

| | | Diameter | |
|---|---|---|---|
| | Type | [nm] | Moisture content[%] |
| Ex. 1 | Barium ferrite magnetic powder | 20 | 1.0 |
| Ex. 2 | Barium ferrite magnetic powder | 20 | 1.0 |
| Ex. 3 | Barium ferrite magnetic powder | 20 | 1.0 |
| Ex. 4 | Barium ferrite magnetic powder | 20 | 1.0 |
| Ex. 5 | Barium ferrite magnetic powder | 20 | 1.0 |
| Comp. Ex. 1 | Barium ferrite magnetic powder | 20 | 1.0 |
| Ex. 6 | Barium ferrite magnetic powder | 20 | 1.0 |
| Ex. 7 | Barium ferrite magnetic powder | 20 | 1.0 |
| Ex. 8 | Barium ferrite magnetic powder | 20 | 1.0 |
| Ex. 9 | Barium ferrite magnetic powder | 20 | 1.0 |
| Ex. 10 | Barium ferrite magnetic powder | 20 | 1.0 |
| Ex. 11 | Barium ferrite magnetic powder | 20 | 1.0 |
| Ex. 12 | Barium ferrite magnetic powder | 20 | 1.0 |
| Ex. 13 | Barium ferrite magnetic powder | 20 | 1.0 |
| Comp. Ex. 2 | Barium ferrite magnetic powder | 20 | 1.0 |
| Comp. Ex. 3 | Barium ferrite magnetic powder | 20 | 1.0 |
| Comp. Ex. 4 | Barium ferrite magnetic powder | 20 | 1.0 |
| Comp. Ex. 5 | Barium ferrite magnetic powder | 20 | 1.0 |
| Ex. 14 | Barium ferrite magnetic powder | 20 | 1.0 |
| Ex, 15 | Barium ferrite magnetic powder | 20 | 1.0 |
| Comp. Ex. 6 | Barium ferrite magnetic powder | 20 | 1.0 |
| Ex. 16 | Barium ferrite magnetic powder | 20 | 1.0 |
| Ex. 17 | Barium ferrite magnetic powder | 20 | 1.0 |
| Ex. 18 | Barium ferrite magnetic powder | 20 | 1.0 |
| Ex. 19 | Barium ferrite magnetic powder | 20 | 1.0 |
| Ex. 20 | Barium ferrite magnetic powder | 20 | 1.0 |
| Comp. Ex. 7 | Barium ferrite magnetic powder | 5 | 1.0 |
| Ex. 21 | Barium ferrite magnetic powder | 10 | 1.0 |
| Ex. 22 | Barium ferrite magnetic powder | 30 | 1.0 |
| Comp. Ex. 8 | Barium ferrite magnetic powder | 60 | 1.0 |
| Comp. Ex. 9 | Barium ferrite magnetic powder | 20 | 1.0 |
| Ex. 23 | Barium ferrite magnetic powder | 20 | 1.0 |
| Ex. 24 | Barium ferrite magnetic powder | 20 | 1.0 |
| Ex. 25 | Barium ferrite magnetic powder | 20 | 1.0 |
| Comp. Ex. 10 | Barium ferrite magnetic powder | 20 | 1.0 |
| Comp. Ex. 11 | Barium ferrite magnetic powder | 20 | 0.1 |
| Ex. 26 | Barium ferrite magnetic powder | 20 | 0.3 |
| Ex. 27 | Barium ferrite magnetic powder | 20 | 3.0 |
| Comp. Ex. 12 | Barium ferrite magnetic powder | 20 | 4.0 |
| Ex. 28 | Ferromagnetic metal powder | 40 | 0.9 |

| | Component B | | | Component C | |
|---|---|---|---|---|---|
| | | | Quantity | | Quantity |
| | | | of | | added |
| | Weight average | Type of | polar | | [weight |
| | molecular weight | polar group | group[meq/g] | Type | parts] |
| Ex. 1 | 70,000 | SO₃Na | 0.35 | 1-naphthoic acid | 5 |
| Ex. 2 | 120,000 | SO₃Li | 0.35 | 1-naphthoic acid | 5 |
| Ex. 3 | 70,000 | COOH | 0.35 | 1-naphthoic acid | 5 |
| Ex. 4 | 70,000 | PO(ONa)₂ | 0.35 | 1-naphthoic acid | 5 |
| Ex. 5 | 70,000 | OSO₃H | 0.35 | 1-naphthoic acid | 5 |
| Comp. Ex. 1 | 70,000 | None | None | 1-naphthoic acid | 5 |
| Ex. 6 | 70,000 | SO₃Na | 0.35 | Catechol | 3 |
| Ex. 7 | 70,000 | SO₃Na | 0.35 | Phenol | 3 |
| Ex. 8 | 70,000 | SO₃Na | 0.35 | Phthalic acid | 5 |
| Ex. 9 | 70,000 | SO₃Na | 0.35 | 4-tert-butylphenol | 5 |
| Ex. 10 | 70,000 | SO₃Na | 0.35 | 4-tert-butylbenzoic acid | 5 |
| Ex. 11 | 70,000 | SO₃Na | 0.35 | 4-butylphenol | 5 |
| Ex. 12 | 70,000 | SO₃Na | 0.35 | 4-hydroxypyridine | 3 |
| Ex. 13 | 70,000 | SO₃Na | 0.35 | Cyclohexanecarboxylic acid | 4 |
| Comp. Ex. 2 | 70,000 | SO₃Na | 0.35 | Aniline | 5 |
| Comp. Ex. 3 | 70,000 | SO₃Na | 0.35 | None | None |
| Comp. Ex. 4 | 70,000 | SO₃Na | 0.05 | None | None |
| Comp. Ex. 5 | 70,000 | SO₃Na | 0.05 | 1-naphthoic acid | 5 |
| Ex. 14 | 70,000 | SO₃Na | 0.20 | 1-naphthoic acid | 5 |
| Ex, 15 | 70,000 | SO₃Na | 0.70 | 1-naphthoic acid | 5 |
| Comp. Ex. 6 | 70,000 | SO₃Na | 0.90 | 1-naphthoic acid | 5 |
| Ex. 16 | 70,000 | SO₃Na | 0.35 | 1-naphthoic acid | 1 |
| Ex. 17 | 70,000 | SO₃Na | 0.35 | Catechol | 1 |
| Ex. 18 | 70,000 | SO₃Na | 0.35 | 1-naphthoic acid | 3 |
| Ex. 19 | 70,000 | SO₃Na | 0.35 | Catechol | 8 |
| Ex. 20 | 70,000 | SO₃Na | 0.35 | 1-naphthoic acid | 10 |
| Comp. Ex. 7 | 70,000 | SO₃Na | 0.35 | 1-naphthoic acid | 5 |
| Ex. 21 | 70,000 | SO₃Na | 0.35 | 1-naphthoic acid | 5 |
| Ex. 22 | 70,000 | SO₃Na | 0.35 | 1-naphthoic acid | 5 |
| Comp. Ex. 8 | 70,000 | SO₃Na | 0.35 | 1-naphthoic acid | 5 |
| Comp. Ex. 9 | 15,000 | SO₃Na | 0.35 | 1-naphthoic acid | 5 |
| Ex. 23 | 25,000 | SO₃Na | 0.35 | 1-naphthoic acid | 5 |
| Ex. 24 | 140,000 | SO₃Na | 0.35 | 1-naphthoic acid | 5 |
| Ex. 25 | 200,000 | SO₃Na | 0.35 | 1-naphthoic acid | 5 |
| Comp. Ex. 10 | 300,000 | SO₃Na | 0.35 | 1-naphthoic acid | 5 |
| Comp. Ex. 11 | 70,000 | SO₃Na | 0.35 | 1-naphthoic acid | 5 |
| Ex. 26 | 70,000 | SO₃Na | 0.35 | 1-naphthoic acid | 5 |
| Ex. 27 | 70,000 | SO₃Na | 0.35 | 1-naphthoic acid | 5 |
| Comp. Ex. 12 | 70,000 | SO₃Na | 0.35 | 1-naphthoic acid | 5 |
| Ex. 28 | 70,000 | SO₃Na | 0.35 | 4-tert-butylphenol | 5 |

| | Surface property | | |
|---|---|---|---|
| | Ra[nm] | S/N [dB] | Head grime |
| Ex. 1 | 2.2 | 25 | Excellent |
| Ex. 2 | 2.3 | 24 | Excellent |
| Ex. 3 | 2.7 | 22 | Excellent |
| Ex. 4 | 2.5 | 23 | Excellent |
| Ex. 5 | 2.5 | 22 | Excellent |
| Comp. Ex. 1 | 4.0 | 12 | Excellent |
| Ex. 6 | 2.3 | 25 | Excellent |
| Ex. 7 | 2.5 | 24 | Excellent |
| Ex. 8 | 2.6 | 22 | Excellent |
| Ex. 9 | 2.2 | 24 | Excellent |
| Ex. 10 | 2.2 | 24 | Excellent |
| Ex. 11 | 2.3 | 25 | Excellent |
| Ex. 12 | 2.1 | 22 | Excellent |
| Ex. 13 | 2.2 | 23 | Excellent |
| Comp. Ex. 2 | 3.4 | 17 | Excellent |
| Comp. Ex. 3 | 2.2 | 25 | Poor |
| Comp. Ex. 4 | 4.2 | 12 | Excellent |
| Comp. Ex. 5 | 3.3 | 17 | Excellent |
| Ex. 14 | 2.3 | 23 | Excellent |
| Ex, 15 | 2.6 | 22 | Excellent |
| Comp. Ex. 6 | 3.5 | 17 | Excellent |
| Ex. 16 | 2.4 | 23 | Excellent |
| Ex. 17 | 1.9 | 25 | Excellent |
| Ex. 18 | 2.1 | 23 | Excellent |
| Ex. 19 | 2.1 | 23 | Excellent |
| Ex. 20 | 2.5 | 23 | Excellent |
| Comp. Ex. 7 | 1.5 | — | Poor(Coating separation)^{Note)} |
| Ex. 21 | 1.3 | 26 | Excellent |
| Ex. 22 | 2.0 | 23 | Excellent |
| Comp. Ex. 8 | 2.6 | 15 | Excellent |
| Comp. Ex. 9 | 2.7 | 20 | Poor |
| Ex. 23 | 2.5 | 22 | Excellent |
| Ex. 24 | 2.5 | 25 | Excellent |
| Ex. 25 | 2.8 | 20 | Excellent |
| Comp. Ex. 10 | 3.4 | 14 | Excellent |
| Comp. Ex. 11 | 3.4 | 15 | Excellent |
| Ex. 26 | 2.7 | 23 | Excellent |
| Ex. 27 | 2.7 | 22 | Excellent |
| Comp. Ex. 12 | 3.3 | 15 | Excellent |
| Ex. 28 | 2.8 | 21 | Excellent |

^{Note)}The coating separated to a degree precluding evaluation of the S/N ratio.

| | | Surface | | |
|---|---|---|---|---|
| | | property | | |
| | Mixing method | Ra[nm] | S/N[dB] | Head grime |
| Ex. 1 | Component B was added to the mixture | 2.2 | 25 | Excellent |
| | of components A and C. | | | |
| Ex. 29 | For the same components as in Example | 2.2 | 25 | Excellent |
| | 1, components A, B, and C were | | | |
| | simultaneously mixed. | | | |

### Evaluation Results

Examples 1 to 29 produced smooth magnetic layers and exhibited good electromagnetic characteristics. Despite the good surface property of the magnetic layer, no head grime was observed.

In Comparative Example 1, in which a binder that did not contain the prescribed polar group was employed, the surface of the magnetic layer was rough and good electromagnetic characteristics could not be achieved.

In Comparative Example 2, in which the compound having a carboxyl group and/or a hydroxyl group serving as a surface modifying agent was replaced with a cyclic compound (aniline) having neither a carboxyl group nor a hydroxyl group, there was inadequate dispersion of the magnetic layer and the smoothness of the magnetic layer surface decreased, resulting in diminished electromagnetic characteristics.

In Comparative Example 3, in which no surface modifying agent was added, head grime occurred. This was attributed to severing of the binder through contact with the magnetic material, resulting in the presence of a large quantity of low-molecular-weight compounds on the surface of the magnetic layer.

In Comparative Examples 4 and 5, in which few polar groups were present in the binder, the surface of the magnetic layer was rough and the electromagnetic characteristics deteriorated. Conversely, in Comparative Example 6, in which the quantity of polar groups in the binder was excessive, the electromagnetic characteristics deteriorated.

In Comparative Example 7, the particle diameter of the ferromagnetic powder was excessively small, and, as set forth above, the bonds between magnetic particles weakened, the coating strength of the magnetic layer diminished, and the coating separated to a degree precluding evaluation of the S/N ratio. By contrast, in Comparative Example 8, in which the particle diameter of the ferromagnetic powder was excessively large, the electromagnetic characteristics deteriorated.

In Comparative Example 9, in which the weight average molecular weight of the binder was low, head grime occurred. This was attributed to the presence of a large number of low-molecular-weight compounds on the surface of the magnetic layer.

In Comparative Example 10, in which the weight average molecular weight of the binder exceeded 200,000, the dispersion of the magnetic layer was inadequate and the electromagnetic characteristics deteriorated.

In Comparative Example 11, the moisture content of the magnetic material was low, the magnetic layer surface was rough, and the electromagnetic characteristics deteriorated. This was attributed to the binder not being able to adequately adsorb to the magnetic material. In Comparative Example 12, in which the moisture content of the magnetic material was excessive, the magnetic layer surface was rough and the electromagnetic characteristics deteriorated. This was attributed to the high moisture content causing the reaction with the polyisocyanate in the magnetic layer coating liquid to advance excessively, resulting in a rough magnetic layer surface.

The magnetic recording medium of the present invention is suitable as a magnetic recording medium for high-density recording.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. A method of manufacturing a magnetic recording medium comprising:
coating a magnetic layer coating liquid on a nonmagnetic support and drying the magnetic layer coating liquid to form a magnetic layer, wherein
the magnetic layer coating liquid comprises components A, B and C.
Component A: A ferromagnetic powder having an average particle size ranging from 10 to 40 nm and having a moisture content ranging from 0.3 to 3.0 weight percent;
Component B: a binder (a) comprising 0.2 to 0.7 meq/g of at least one polar group selected from the group consisting of —SO₃M, —OSO₃M, —PO(OM)₂, —OPO(OM)₂, and COOM, wherein M denotes a hydrogen atom, alkali metal, or ammonium, and having a weight average molecular weight ranging from 20,000 to 200,000, and/or (b) comprising 0.5 to 5 meq/g of at least one polar group selected from the group consisting of —CONR¹R², —NR¹R², and —N⁺R¹R²R³, wherein R¹, R², and R³ each independently denote a hydrogen atom or an alkyl group, and having a weight average molecular weight ranging from 20,000 to 200,000; and
Component C: a compound comprising at least one carboxyl group and/or hydroxyl group per molecule.

2. The method of manufacturing a magnetic recording medium according to claim 1, which comprises preparing the magnetic layer coating liquid by simultaneously mixing components A, B, and C, or by mixing components A and C to obtain a mixture and mixing component B to the mixture.

3. The method of manufacturing a magnetic recording medium according to claim 1, wherein component B is a binder (a) comprising 0.2 to 0.7 meq/g of at least one polar group selected from the group consisting of —SO₃M, —OSO₃M, —PO(OM)₂, —OPO(OM)₂, and COOM, wherein M denotes a hydrogen atom, alkali metal, or ammonium, and having a weight average molecular weight ranging from 20,000 to 200,000.

4. The method of manufacturing a magnetic recording medium according to claim 1, wherein the compound comprising at least one carboxyl group and/or hydroxyl group per molecule is a cyclic compound.

5. The method of manufacturing a magnetic recording medium according to claim 4, wherein the cyclic compound is at least one compound selected from the group consisting of alicyclic compounds, aromatic compounds, and heterocyclic compounds.

6. The method of manufacturing a magnetic recording medium according to claim 4, wherein a cyclic structure comprised in the cyclic compound is at least one selected from the group consisting of cyclohexane rings, benzene rings, pyridine rings, and naphthalene rings.

7. The method of manufacturing a magnetic recording medium according to claim 1, wherein the ferromagnetic powder is a hexagonal ferrite powder.

8. The method of manufacturing a magnetic recording medium according to claim 1, wherein the binder is a polyurethane resin.

9. The method of manufacturing a magnetic recording medium according to claim 1, which manufactures a magnetic recording medium comprising a magnetic layer, the surface of which has a centerline average roughness ranging from 1.0 to 3.0 nm.

10. A magnetic recording medium comprising a magnetic layer comprising a ferromagnetic powder and a binder on a nonmagnetic support, manufactured by the method according to claim 1.

11. The magnetic recording medium according to claim 10, wherein a centerline average roughness of the magnetic layer surface ranges from 1.0 to 3.0 nm.
